(19) United States
(12) Patent Application Publication
(10) Pub. No.: US 2022/0232477 A1
(43) Pub. Date: Jul. 21, 2022

(54) DOWNLINK TRAFFIC JITTER HANDLING FOR XR UE POWER SAVING

(71) Applicant: QUALCOMM Incorporated, San Diego, CA (US)

(72) Inventors: Yuchul KIM, San Diego, CA (US); Hwan Joon KWON, San Diego, CA (US); Peter Pui Lok ANG, San Diego, CA (US); Jay Kumar SUNDARARAJAN, San Diego, CA (US); Krishna Kiran MUKKAVILLI, San Diego, CA (US); Yeliz TOKGOZ, San Diego, CA (US); Huilin XU, Temecula, CA (US); Jing LEI, San Diego, CA (US); Yongjun KWAK, San Diego, CA (US); Wanshi CHEN, San Diego, CA (US)

(21) Appl. No.: 17/646,474

(22) Filed: Dec. 29, 2021

Related U.S. Application Data
(60) Provisional application No. 63/138,191, filed on Jan. 15, 2021.
(60) Provisional application No. 63/261,778, filed on Sep. 28, 2021.

(51) Int. Cl. H04W 52/02

(52) U.S. Cl. CPC H04W 52/0235

(57) ABSTRACT

A configuration for handling downlink traffic jitter in wireless communication systems. The apparatus receives a configuration from a base station comprising a configuration for DRX operation based on a scheduled arrival time of data, wherein the configuration comprises a time offset for a WUS occasion or a DRX on duration for a plurality of DRX cycles of the DRX operation. The apparatus monitors for communication from the base station based on the time offset associated with the WUS occasion or the DRX on duration for each of the plurality of DRX cycles.

### CROSS REFERENCE TO RELATED APPLICATION(S)

This application claims the benefit of and priority to U.S. Provisional Application Ser. No. 63/138,191, entitled “Downlink Traffic Jitter Handling for XR UE Power Saving” and filed on Jan. 15, 2021, and to U.S. Provisional Application Ser. No. 63/261,778, entitled “Downlink Traffic Jitter Handling for XR UE Power Saving” and filed on Sep. 28, 2021 which are expressly incorporated by reference herein in their entirety.

### TECHNICAL FIELD

The present disclosure relates generally to communication systems, and more particularly, to a configuration for handling downlink traffic jitter in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a configuration from a base station comprising a configuration for discontinuous reception (DRX) operation based on a scheduled arrival time of data. The configuration comprises a time offset for a wake up signal (WUS) occasion or a DRX on duration for a plurality of DRX cycles of the DRX operation. The apparatus monitors for communication from the base station based on the time offset associated with the WUS occasion or the DRX on duration for each of the plurality of DRX cycles.

In an aspect of the disclosure, a method, a computer-readable medium, and an apparatus are provided. The apparatus may be a device at a UE. The device may be a processor and/or a modem at a UE or the UE itself. The apparatus receives a configuration from a base station comprising a configuration for DRX operation. The configuration comprises a sequence based WUS such that DRX operation is based on a sequence detected within the WUS. The apparatus monitors for communication from the base station based on the sequence based WUS.

In an aspect of the disclosure, a method, a computer-readable medium, and an apparatus are provided. The apparatus may be a device at a UE. The device may be a processor and/or a modem at a UE or the UE itself. The apparatus receives a configuration from a base station comprising a configuration for DRX operation, wherein the configuration comprises a WUS configuration comprising a plurality of WUS occasions within a DRX on duration of the DRX operation. The apparatus monitors for communication from the base station based on the WUS configuration.

In an aspect of the disclosure, a method, a computer-readable medium, and an apparatus are provided. The apparatus may be a device at a UE. The device may be a processor and/or a modem at a UE or the UE itself. The apparatus receives a configuration from a base station comprising a configuration for DRX operation, wherein the configuration comprises at least one blind decode indication during a DRX on duration of the DRX operation. The apparatus monitors for the at least one blind decode indication during the DRX on duration. The apparatus performs a blind decode operation based on the at least one blind decode indication.

In an aspect of the disclosure, a method, a computer-readable medium, and an apparatus are provided. The apparatus may be a device at a UE. The device may be a processor and/or a modem at a UE or the UE itself. The apparatus receives a configuration from a base station comprising a configuration for semi-persistent scheduling (SPS) occasions. The apparatus monitors for communication from the base station based on the SPS occasions, wherein the SPS occasions are scheduled to correspond with a scheduled arrival time of data.

In an aspect of the disclosure, a method, a computer-readable medium, and an apparatus are provided. The apparatus may be a device at a base station. The device may be a processor and/or a modem at a base station or the base station itself. The apparatus configuring a user equipment (UE) with a configuration for DRX operation based on a scheduled arrival time of data. The configuration comprises a time offset for a WUS occasion or a DRX on duration for a plurality of DRX cycles of the DRX operation. The apparatus transmits communication to the UE based on the time offset associated with the WUS occasion or the DRX on duration for each of the plurality of DRX cycles.

In an aspect of the disclosure, a method, a computer-readable medium, and an apparatus are provided. The apparatus may be a device at a base station. The device may be a processor and/or a modem at a base station or the base station itself. The apparatus configures a UE with a configuration for DRX operation, wherein the configuration comprises a sequence based WUS such that DRX operation is based on a sequence detected within the WUS. The apparatus transmits communication to the UE based on the sequence based WUS.

In an aspect of the disclosure, a method, a computer-readable medium, and an apparatus are provided. The apparatus may be a device at a base station. The device may be a processor and/or a modem at a base station or the base station itself. The apparatus configures a UE with a configuration for DRX operation, wherein the configuration comprises a WUS configuration comprising a plurality of WUS occasions within a DRX on duration of the DRX operation. The apparatus transmits communication to the UE based on the WUS configuration.

In an aspect of the disclosure, a method, a computer-readable medium, and an apparatus are provided. The apparatus may be a device at a base station. The device may be a processor and/or a modem at a base station or the base station itself. The apparatus configures a UE with a configuration for DRX operation, wherein the configuration comprises at least one blind decode indication during a DRX on duration of the DRX operation. The apparatus transmits the at least one blind decode indication during the DRX on duration, wherein the UE performs a blind decode operation based on the at least one blind decode indication.

In an aspect of the disclosure, a method, a computer-readable medium, and an apparatus are provided. The apparatus may be a device at a base station. The device may be a processor and/or a modem at a base station or the base station itself. The apparatus configures a UE with a configuration for SPS occasions. The apparatus transmits communication to the UE based on the SPS occasions, wherein the SPS occasions are scheduled to correspond with a scheduled arrival time of data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A-4B are diagrams illustrating examples of early and late data arrivals.

FIG. 5 is a diagram illustrating an example of a DRX configuration.

FIG. 6 is a diagram illustrating an example of a DRX configuration.

FIG. 7 is a diagram illustrating an example of a DRX configuration.

FIG. 8 is a diagram illustrating an example of a DRX configuration.

FIG. 9A is a diagram illustrating an example of a DRX configuration.

FIG. 9B is a diagram illustrating an example of a DRX configuration.

FIG. 10 is a diagram illustrating an example of a DRX configuration.

FIG. 11 is a diagram illustrating an example of an SPS configuration.

FIG. 12 is a call flow diagram of signaling between a UE and a base station in accordance with certain aspects of the disclosure.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a diagram illustrating an example of a hardware implementation for an example apparatus.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a flowchart of a method of wireless communication.

FIG. 27 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

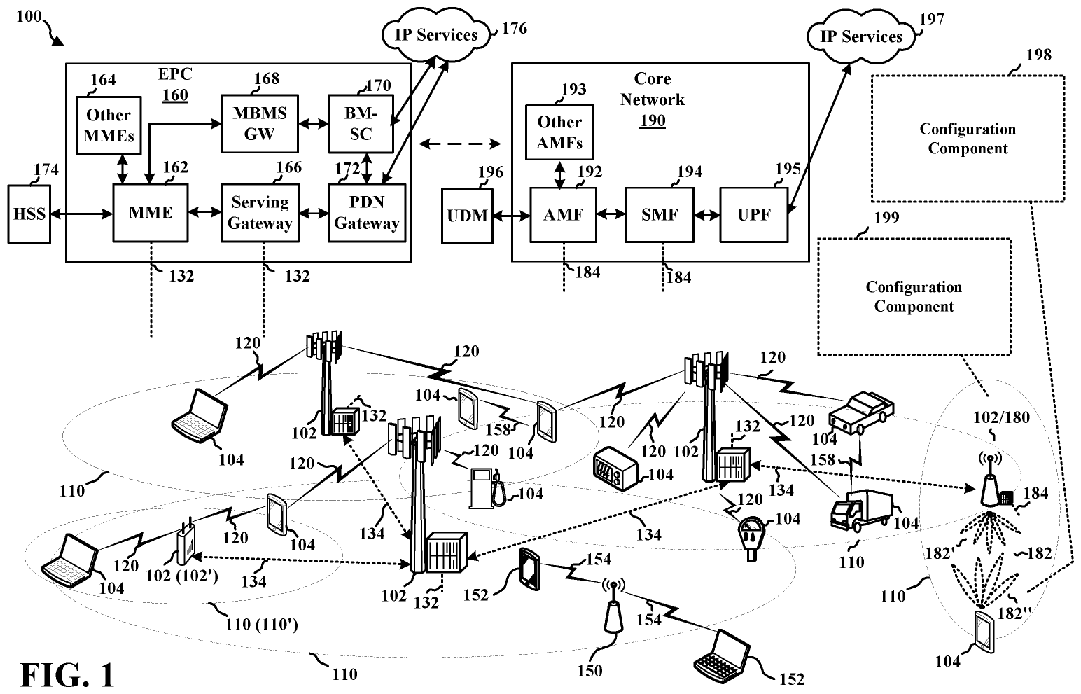

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to wake up or have a DRX on duration start time to be offset from a scheduled arrival time of data. For example, the UE 104 may comprise a configuration component 198 configured to receive a configuration for DRX operation based on the scheduled arrival time of data. The UE 104 receives a configuration from the base station 180 comprising a configuration for DRX operation based on the scheduled arrival time of data, wherein the configuration comprises a time offset for a WUS occasion or a DRX on duration for a plurality of DRX cycles of the DRX operation. The UE 104 monitors for communication from the base station 180 based on the time offset associated with the WUS occasion or the DRX on duration for each of the plurality of DRX cycles.

Referring again to FIG. 1, in certain aspects, the base station 180 may be configured to configure a UE to wake up or have a DRX on duration start time to be offset from a scheduled arrival time of data. For example, the base station 180 may comprise a configuration component 199 configured to configure the UE 104 with a configuration for DRX operation based on the scheduled arrival time of data. The base station 180 configures the UE 104 with the configuration for DRX operation based on a scheduled arrival time of data, wherein the configuration comprises a time offset for a WUS occasion or a DRX on duration for a plurality of DRX cycles of the DRX operation. The base station 180 transmits communication to the UE 104 based on the time offset associated with the WUs occasion or the DRX on duration for each of the plurality of DRX cycles.

Although the following description may be focused on 5G NR, the concepts described herein may be applicable to other similar areas, such as LTE, LTE-A, CDMA, GSM, and other wireless technologies.

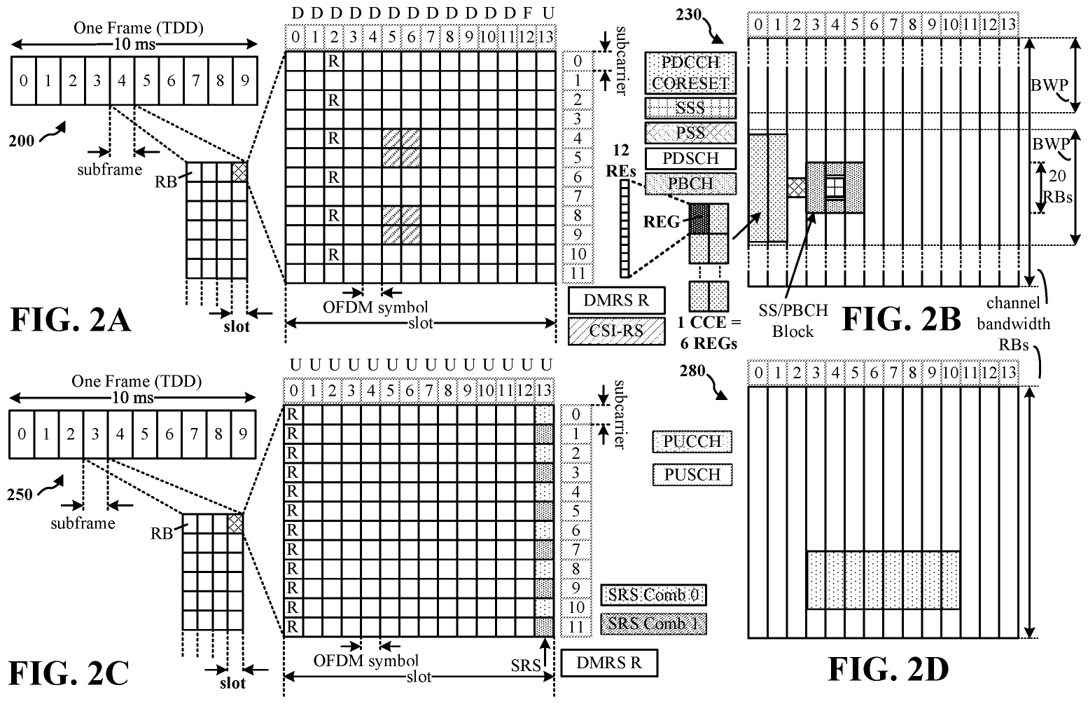

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

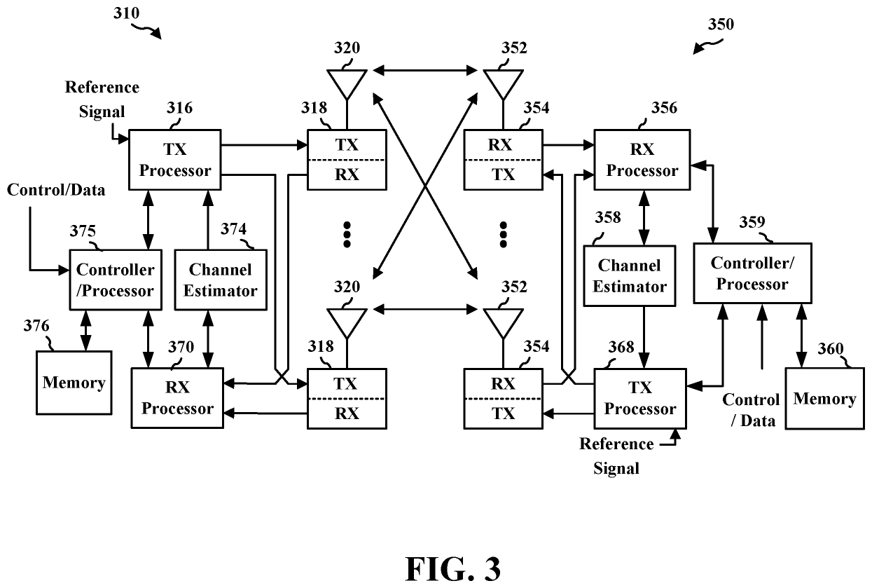

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

In wireless communication systems, XR traffic patterns may be periodic. For example, XR scenes may be rendered (e.g., 50 frames per second) and may then be sent to a wireless device (e.g., UE) over the air. To maintain 50 frames per second, the frame arrival and inter-arrival times may be deterministic. Jitter in arrival timing may be related due to encoding. For example, complex scenes may increase the encoding time. Contributions to jitter may be added due in part to encoder encoding time or periodicity, CN delay, air interface scheduling delay, retransmissions, operating system kernel delay, etc. There may be a spread in measured inter-arrival time of data (e.g., GC traffic), which may be measured at the application layer. The spread of the measured inter-arrival may indicate that UE power increases as well as latency.

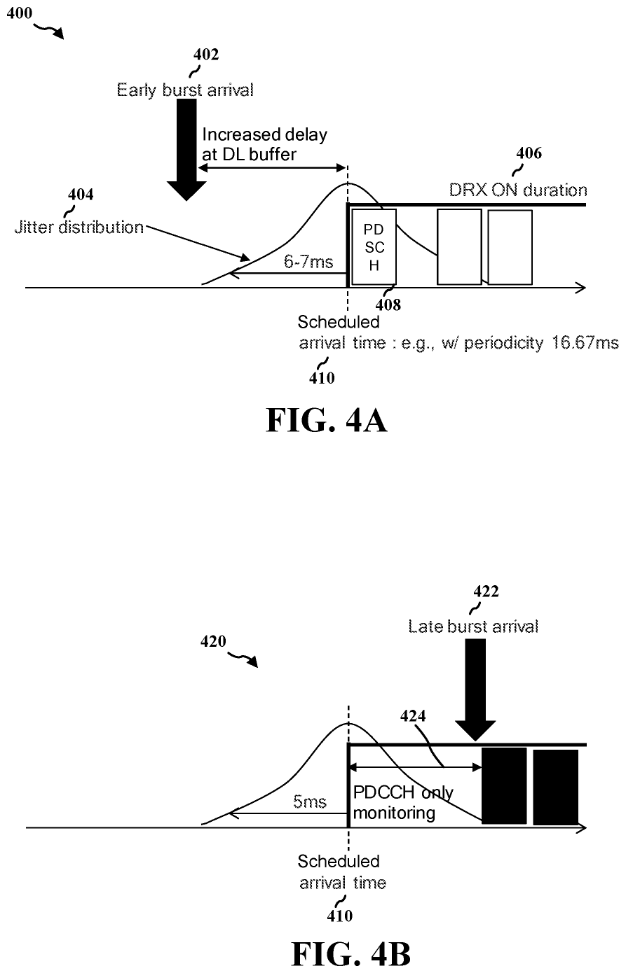

Jitter in XR downlink traffic arrival may affect UE power consumption especially when periodic arrival is assumed (e.g., DRX). For example, FIG. 4A is a diagram 400 illustrating an example of an early data burst arrival. The data burst may comprise a high-bandwidth of data transmitted over a short period of time. The jitter distribution 404 is shown about the scheduled arrival time 410. The scheduled arrival time 410 may be based on a DRX configuration where the UE is scheduled to be activated (e.g., DRX on) for a predetermined periodicity. The jitter distribution 404 may span 6-7 ms about the scheduled arrival time 410, for example. In instances where the burst arrival 402 is early, e.g., prior to the scheduled arrival time 410, the data would have to be buffered and may increase the delay at the downlink buffer. The UE may enter a DRX on duration 406 and receive PDSCH 408 after the scheduled arrival time. With reference to FIG. 4B which is a diagram 420 illustrating an example of a late burst arrival. The burst arrival 422 may arrive late, after the scheduled arrival time 410, such that the UE wakes up at the scheduled arrival time 410, but the UE may only monitor for PDCCH until the burst arrival 422. As such, UE power is wasted due to PDCCH only decoding until the burst arrival 422.

Aspects provided herein provide a configuration for handling downlink traffic jitter in wireless communication systems. For example, a UE may be configured with a DRX configuration or SPS configuration to account for jitter in the reception of downlink data which may lead to a reduction of power utilized by the UE.

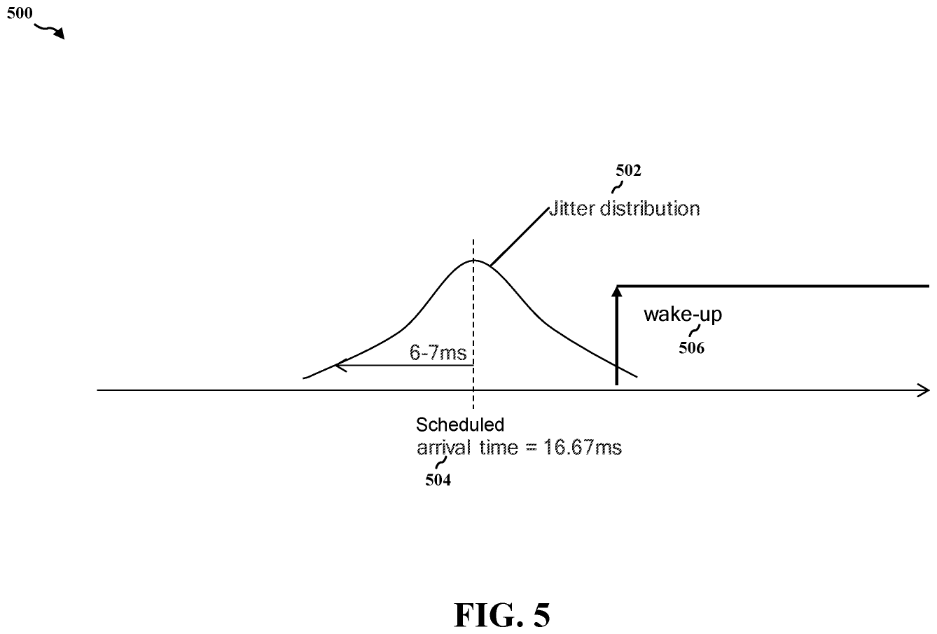

FIG. 5 is a diagram 500 illustrating an example of a DRX configuration. In the diagram 500, the jitter distribution 502 is about the scheduled arrival time 504 and may have a span of 6-7 ms. However, the jitter distribution 502 may have a span that is less than or greater than 6-7 ms and the disclosure is not intended to be limited to the examples disclosed herein. In the diagram 500, the UE may be configured with a wake up time or a DRX on duration start time that is configured to be later than the scheduled arrival time 504. For example, the UE may have a start wake-up 506 that is offset from the scheduled arrival time 504 in an effort to minimize the effects of jitter on the downlink signal. The UE may be configured with the offset wake up time or DRX configuration having the DRX on duration start time that is offset from the scheduled arrival time 504 by a base station (not shown). The DRX configuration received from the base station may offset the start of the wake-up 506 such that the UE may wake up after the scheduled arrival time 504 which may increase the likelihood of the UE receiving the data. The wake-up 506 being offset from the scheduled arrival time 504 may allow the UE to avoid unnecessary PDCCH monitoring, and provide a power savings.

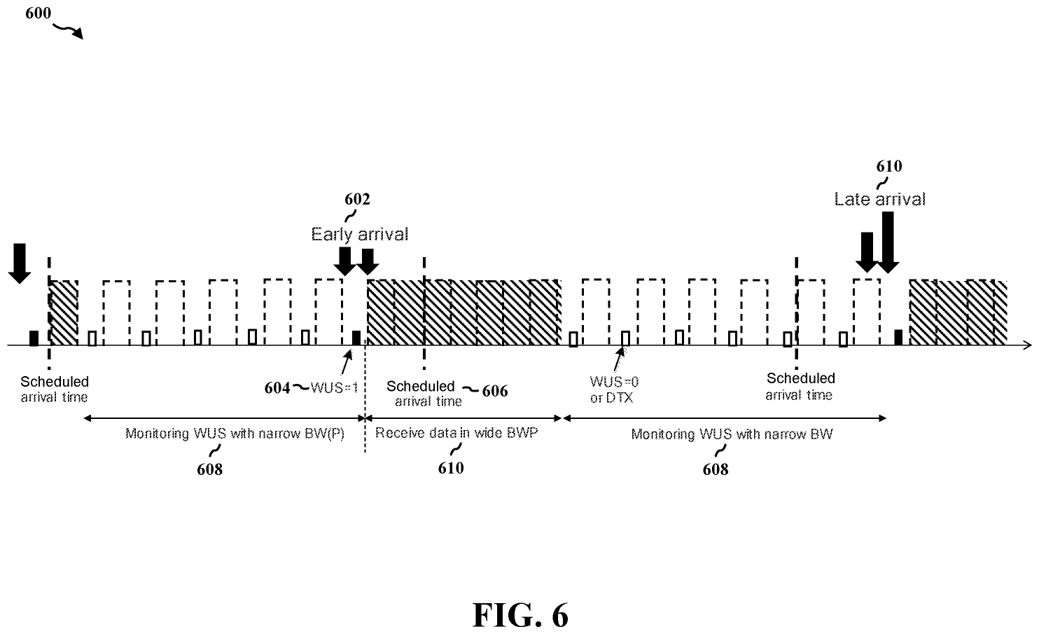

FIG. 6 is a diagram 600 illustrating an example of a DRX configuration. In the diagram 600 includes a WUS having a dense DRX configuration. The UE may receive the DRX configuration from the base station. The DRX configuration may be configured to have a small cycle. The WUS may be configured to be monitored by the UE prior to the DRX on duration. In some instances, the WUS may carry an indication of the bandwidth part (BWP) to be used by the UE. Since monitoring of the WUS occurs frequently, WUS detection power should be reduced in an effort to minimize UE power usage. As such, the WUS may be a sequence based WUS where the sequence based WUS carries a BWP indication. For example, the sequence based WUS may indicate the UE to use the narrowband to monitor for WUS, while indicate the UE to use the wideband to receive data upon arrival of the data. For example, an early arrival 602 of data, with respect to the scheduled arrival time 606, may include the WUS 604, which may inform the UE to utilize the wideband to receive data (e.g., 610), such that the UE may receive data using the wideband. In instances where no data is sent to the UE, the WUS may indicate to the UE to utilize the narrowband to monitor for WUS (e.g., 608). The UE may continue to monitor for WUS using the narrowband until receipt of a WUS indicating the arrival of data. In instances of late arrival 610 of data, with respect to the scheduled arrival time, the UE may continue to use the narrowband to monitor for WUS at the scheduled arrival time until the WUS indicating the arrival of data and the indication to use or switch to the wideband to receive the data.

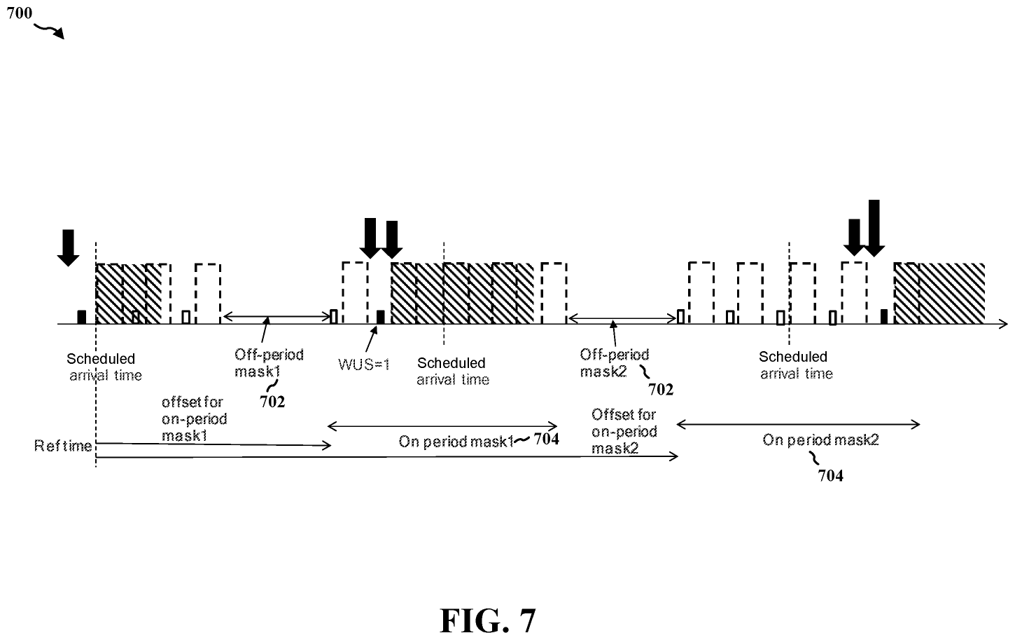

FIG. 7 is a diagram 700 illustrating an example of a DRX configuration. The example of FIG. 7 is similar to the example of FIG. 6, but further includes a DRX mask to reduce WUS monitoring in between adjacent scheduled arrival times of data. The mask may allow the UE to skip WUS monitoring and provide a power savings. For example, the DRX mask may comprise an off period mask 702 or an on period mask 704. The off period mask 702 may include an off period during which the UE does not monitor for WUS and may skip potential DRX on durations. The potential DRX on durations may comprise a scheduled DRX on duration that may or may not be activated by a WUS. In some instances, a DRX on duration triggered by the WUS may begin after the scheduled start time of the potential DRX on duration. The off period due to the off period mask 702 may be configurable by a set of parameters, such as but not limited to periodicity and offsets for off period masks. The on period mask 704 may include an on period during which the UE monitors for WUS and may wake up due to a WUS indication. The on period mask 704 may be configurable by a set of parameters, such as but not limited to periodicity and offsets for on period masks. The off period mask 702 and/or the on period mask 704 may reduce power consumption at the UE due to a reduction of monitoring of WUS.

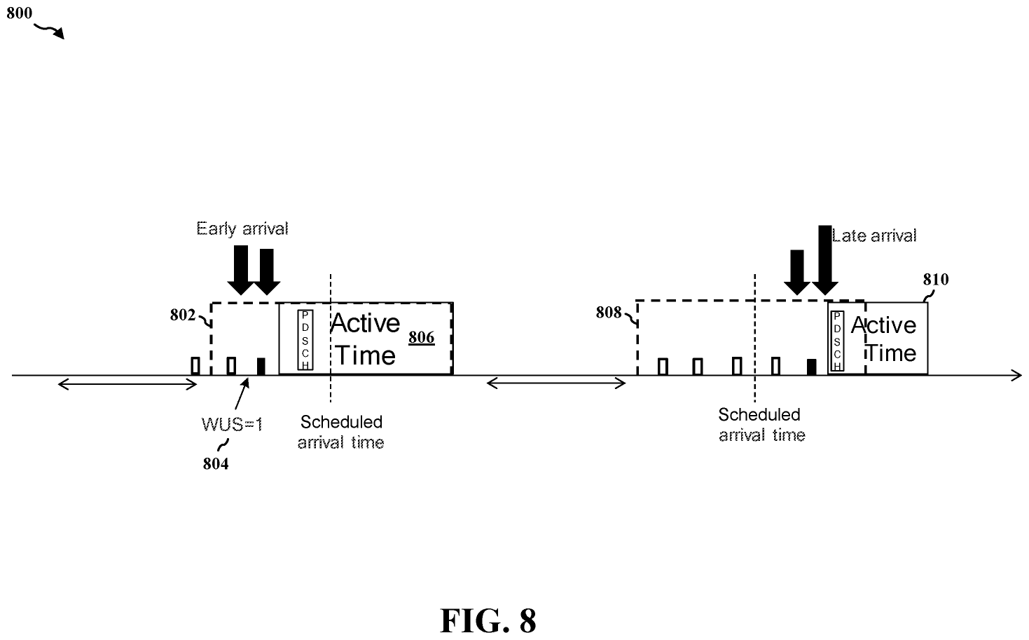

FIG. 8 is a diagram 800 illustrating an example of a DRX configuration. The diagram 800 provides an example of a DRX configuration where the WUS monitoring occurs with an increased size of a WUS window 802, 808. The WUS window 802 may overlap with an on duration, such that the monitored WUS may be received in the middle of an on duration. The WUS may indicate the start of the on duration timer in the middle of the on duration. The WUS may be configured to comprise multiple WUS 804 which may be configured within an on duration. A minimum time gap (e.g., MinTimeGap) may be interpreted as the minimum time gap between a WUS and the time when the on duration timer starts. In some instances, a DRX on duration timer may start in the middle of the on duration if a WUS is received. When starting the on duration timer, the value of the timer may be configured via RRC or a shorter value which may ensure that the on duration timer finishes within the on duration. In some instances, the active time (e.g., 806, 810) may start in the middle of the configured on duration with the start of the on duration timer.

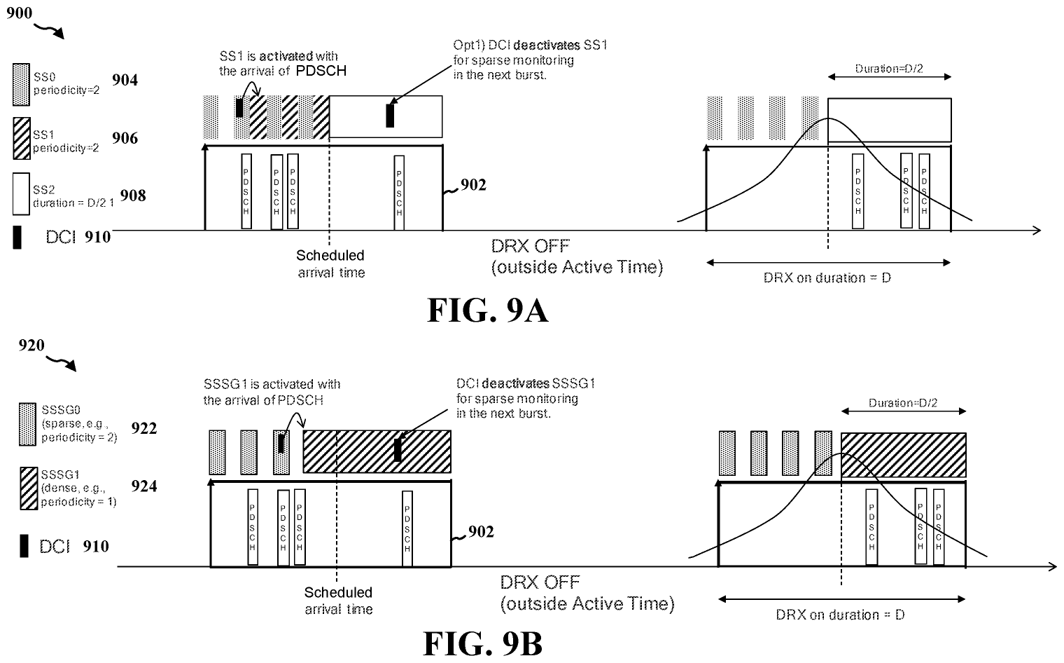

FIG. 9A is a diagram 900 illustrating an example of a DRX configuration. The diagram 900 includes a sparse search space configuration and a dynamic SSS activation/deactivation. The diagram 900 may include a DRX on duration 902 that may be configured to be relatively large. In some instances, prior to the scheduled arrival time, the sparse search space (SS) sets may comprise a first set SS0 904 and a second set SS1 906. In some aspects, the first set SS0 904 may be active in the beginning of the DRX on duration 902, such that the UE may perform sparse monitoring of PDCCH. If data arrives, then an additional SS set SS1 906 may be activated (e.g., by DCI) to provide dense monitoring of PDCCH. After the scheduled data arrival time, a dense SS set SS2 908 may be activated and the UE may perform dense monitoring of the PDCCH. In some aspects, an SS set may be deactivated. For example, DCI may deactivate SS1 906 before receipt of the next burst of data. In some aspects, the SS1 906 may be configured to be deactivated based on predefined events, such as but not limited to switching to a DRX off state, expiration of an inactivity timer, etc.

FIG. 9B is a diagram 920 illustrating an example of a DRX configuration. The diagram 920 includes a sparse search space set group (SSSG) and a dense SSSG activation/deactivation. The diagram 920 may include a DRX on duration 902 that may be configured to be relatively large. In some instances, prior to the scheduled arrival time the SSSG may comprise a first SSSG0 922. The first SSSG0 922 may be a sparse SSSG. In some aspects, the first SSSG0 922 may be active in the beginning of the DRX on duration 902, such that the UE may perform sparse monitoring of PDCCH. Sparse monitoring may comprise non-continuous monitoring where monitoring occasions are separated by extended time intervals, such that monitoring is reduced over a period of time. If data arrives, then an additional SSSG SSSG1 924 may be activated (e.g., via DCI) to activate dense monitoring of PDCCH, such that the UE may switch from sparse monitoring via SSSG0 922 to dense monitoring via SSSG1 924. In some aspects, the switching or activation between sparse monitoring of PDCCH and dense monitoring of PDCCH may be explicitly indicated by a value in the DCI or may be implicitly switch based on receipt of the downlink grant (e.g., initial downlink HARQ transmission). Dense monitoring may comprise continuous monitoring for a period of time, or may comprise monitoring occasions that are separated by a short time interval, such that monitoring is increased or continuous over the period of time. In some aspects, the UE may automatically switch to SSSG1 924 for dense monitoring of PDCCH after the scheduled burst arrival time. In some aspects, the SSSG may be deactivated. For example, the SSSG1 924 may be deactivated and switched to SSSG0 922 prior to the start time of the next data burst start. In some aspects, if the current SSSG is different from a default SSSG (e.g., SSSG0 922), the current SSSG may be automatically deactivated or switched to the default (e.g., sparse) SSSG (e.g., SSSG0 922) upon the occurrence of a predefined event. In some aspects, the occurrence of the predefined event may comprise switching to outside of the active time (e.g., DRX off) or expiration of an inactivity timer. For example, the SSSG1 924 may be deactivated and the SSSG0 922 may be activated based on the occurrence of the predefined event or the expiration of the activity timer.

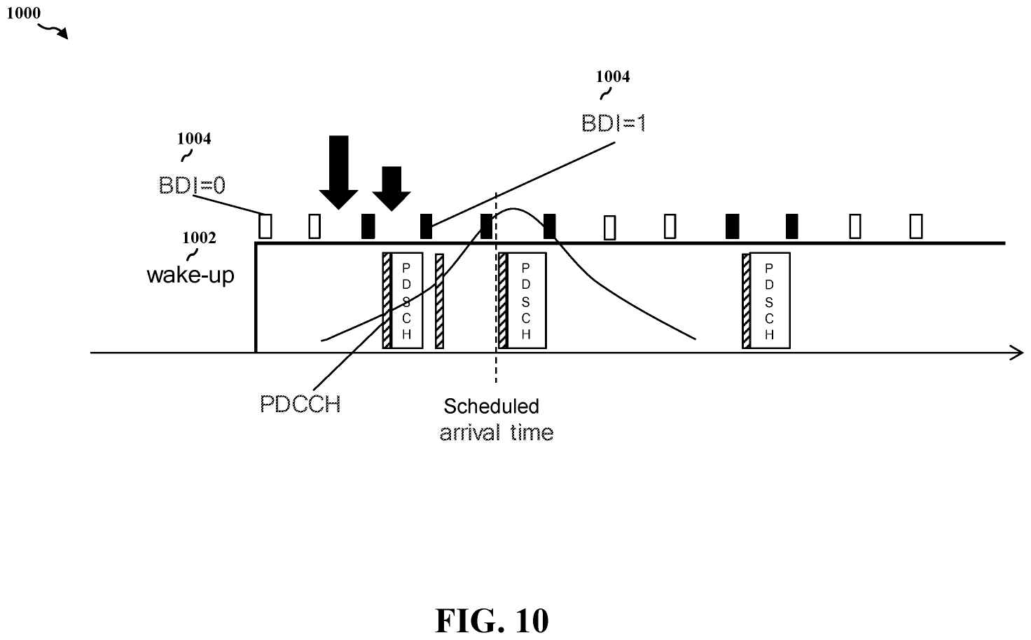

FIG. 10 is a diagram 1000 illustrating an example of a DRX configuration. In instances where the UE is in a wake up state 1002, the network (e.g., base station) may send a control signal indicating PDCCH transmission. The control signal may occur frequently. For example, the control signal may comprise a blind decode indicator 1004. The blind decode indicator 1004 may inform the UE to perform blind decoding only as indicated by the blind decode indicator 1004. The blind decode indicator 1004 may be configured based on periodicity, offset, time frequency resource to monitor the blind decode indicator 1004, etc. The UE may be configured to keep monitoring the configured blind decode indicator 1004. The UE may perform blind decoding (e.g., PDCCH monitoring) only when the blind decode indicator 1004 informs the UE to perform the blind decoding. In some aspects, the UE may monitor for the blind decode indicator 1004, then perform the blind decoding as indicated by the blind decode indicator where the UE monitors for PDCCH, and then may receive PDSCH. The UE utilizes low power for decoding the blind decode indicator 1004.

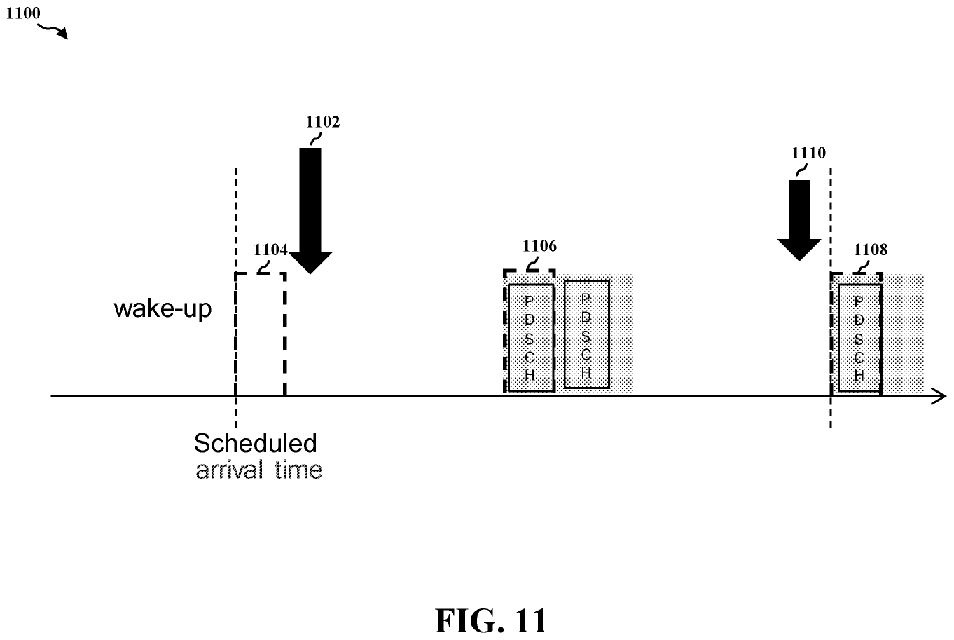

FIG. 11 is a diagram 1100 illustrating an example of an SPS configuration. The diagram 1100 provides an example of an SPS configuration having a reduced period. The UE may be configured to wake up two times during a downlink burst period. For example, the UE may wake up at a first SPS occasion 1104 and at a second SPS occasion 1106 during a data arrival period of data arrival 1102. If the UE receives a downlink burst 1110 during the first SPS occasion 1108 at the scheduled arrival time, then the UE may skip waking up during the second SPS occasion (not shown). If the UE does not receive a downlink burst 1102 in the first SPS occasion 1104, then the UE may wake up during the second SPS occasion 1106 and receive the second SPS occasion for reception of the downlink burst 1102. In some instances, the downlink burst 1102 may be received either in the first SPS occasion 1104 or the second SPS occasion 1106.

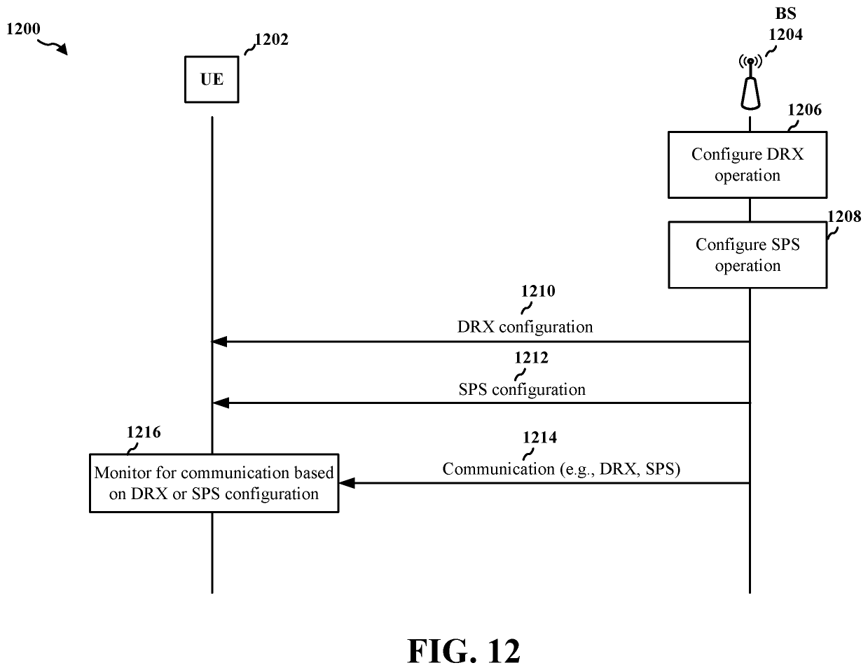

FIG. 12 is a call flow diagram 1200 of signaling between a UE 1202 and a base station 1204. The base station 1204 may be configured to provide at least one cell. The UE 1202 may be configured to communicate with the base station 1204. For example, in the context of FIG. 1, the base station 1204 may correspond to base station 102/180 and, accordingly, the cell may include a geographic coverage area 110 in which communication coverage is provided and/or small cell 102′ having a coverage area 110′. Further, a UE 1202 may correspond to at least UE 104. In another example, in the context of FIG. 3, the base station 1204 may correspond to base station 310 and the UE 1202 may correspond to UE 350. Optional aspects are illustrated with a dashed line.

As illustrated at 1206, the base station 1204 may configure a DRX operation for a UE 1202. In some aspects, the base station 1204 may configure a UE 1202 with a configuration for DRX operation based on a scheduled arrival time of data. The configuration for the DRX operation may comprise a time offset for a WUS occasion or a DRX on duration for a plurality of DRX cycles of the DRX operation. In some aspects, a start time for the WUS occasion or the DRX on duration may be delayed based on the time offset. The start time of the WUS occasion or the DRX on duration may be delayed after the scheduled arrival time of the data based on the time offset. In some aspects, the time offset shifts the start time for the WUS occasion or the DRX on duration to minimize jitter at the scheduled arrival time.

In some aspects, the base station 1204 may configure the UE 1202 with a configuration for DRX operation comprising a sequence based WUS. The DRX operation may be based on a sequence detected within the WUS. In some aspects, the sequence based WUS comprises an indication of a narrow bandwidth or wide bandwidth for the DRX operation, such that the UE 1202 utilizes the narrow bandwidth or the wide bandwidth based on indication detected by the UE 1202. The indication may provide a bandwidth switching between the narrow bandwidth or the wide bandwidth. The bandwidth switching may be associated with reception of the sequenced based WUS by the UE 1202. In some aspects, the sequence based WUS comprises the indication of the narrow bandwidth. The UE 1202 may operate the DRX operation in the narrow bandwidth to monitor for communication from the base station. In some aspects, the sequence based WUS comprises the indication for the wide bandwidth. The UE 1202 may operate the DRX operation in the wide bandwidth to monitor for communication from the base station. In some aspects, the UE 1202 in a DRX on duration of the DRX operation may utilize the wide bandwidth to receive data from the base station.

In some aspects, the base station 1204 may configure the UE 1202 with a configuration for DRX operation comprising a WUS configuration. The WUS configuration may comprise a plurality of WUS occasions within a DRX on duration of the DRX operation. In some aspects, the WUS configuration may comprise a minimum time gap indicating a minimum gap between a WUS and a time when a DRX on duration timer starts. In some aspects, the configuration for the DRX operation may comprise a plurality of DRX on duration timer start occasions. One or more of the plurality of DRX on duration timer start occasions may start after a start of a corresponding scheduled DRX on duration of the DRX operation. In some aspects, each of the plurality of DRX on duration timer start occasions may be associated with a respective WUS monitoring occasion. In some aspects, the potential DRX on duration may be activated during a configured DRX on duration. In some aspects, a value of the DRX on duration timer may be configured via RRC signaling. In some aspects, the value of the DRX on duration timer may be an indicated value. For example, the value of the DRX on duration timer may be indicated in the configuration for the DRX operation. In some aspects, the configuration for the DRX operation may comprise a plurality of search space sets within the DRX on duration and prior to a scheduled arrival time of data. In some aspects, at least one of the plurality of search space sets may be deactivated prior to a subsequent scheduled arrival time of data. In some aspects, a first search space set of the plurality of search space sets may be active at a beginning of the DRX on duration, and a second search space set may be activated if a data set (e.g., PDSCH, PDCCH) is received by the UE within the DRX on duration. The second search space set may be deactivated prior to a next data set being received by the UE. In some aspects, the second search space set may be deactivated based on predefined events. For example, the predefined events may comprise at least switching to a DRX off configuration or an expiration of an inactivity or retransmission timer.

In some aspects, the base station 1204 may configure the UE 1202 with a configuration for DRX operation comprising at least one blind decode indication. The at least one blind decode indication may be during a DRX on duration of the DRX operation. In some aspects, the at least one blind decode indication may be configured based on at least a periodicity, an offset, or a time frequency resource to monitor for the at least one blind decode indication.

As illustrated at 1208, the base station 1204 may configure an SPS operation for the UE 1202. In some aspects, the base station 1204 may configure an SPS operation configuration comprising a configuration for SPS occasions. The base station 1204 may configure the UE 1202 with the SPS operation configuration comprising the configuration for the SPS occasions. In some aspects, the SPS occasions may comprise a first SPS occasion and a second SPS occasion. The UE may not wake up during the second SPS occasion if data is transmitted by the base station and received by the UE during the first SPS occasion. The first SPS occasion may correspond with the scheduled arrival time of the data. In some aspects, the UE may wake up during the second SPS occasion if data is not transmitted by the base station and/or not received by the UE during the first SPS occasion. In some aspects, the first SPS occasion may correspond with the scheduled arrival time of the data and the second SPS occasion may be after the scheduled arrival time of the data but prior to a subsequent arrival time of data.

As illustrated at 1210, the base station may transmit the DRX configuration to the UE 1202, such that the UE 1202 is configured with the DRX configuration. The UE 1202 may receive the DRX configuration from the base station 1204.

As illustrated at 1212, the base station may transmit the SPS configuration to the UE 1202, such that the UE 1202 is configured with the SPS configuration. The UE 1202 may receive the SPS configuration from the base station 1204.

As illustrated at 1216, the UE 1202 may monitor for communication 1214 from the base station 1204 based on the DRX configuration or the SPS configuration. In some aspects, the UE 1202 may monitor for communication from the base station 1204 based on the time offset associated with the WUS occasion or the DRX on duration for each of the plurality of DRX cycles. In some aspects, the UE 1204 does not monitor for PDCCH between the scheduled arrival time and the start time for the WUS occasion or the DRX on duration.

In some aspects, the UE 1202 may monitor for communication 1214 from the base station 1204 based on the sequence based WUS. In some aspects, the sequence based WUS may be monitored before each of a plurality of DRX on durations. Each of the plurality of DRX on durations may have a corresponding WUS occasion to monitor for the sequence based WUS. In some aspects, the configuration may comprise a DRX mask indicating a period to monitor for or not to monitor for the sequence based WUS. The period to monitor for or not to monitor for the sequence based WUS of the DRX mask may be in between scheduled arrival times of data. In some aspects, the DRX mask may comprise an off-period mask. The UE may not monitor for the sequence based WUS during the off-period mask. In some aspects, DRX on durations may be skipped during the off-period mask. In some aspects, the off-period mask may be configured by a set of parameters based on a periodicity and offsets for the off-period mask. In some aspects, the DRX mask may comprise an on-period mask. The UE may monitor for the sequence based WUS during the on-period mask. The UE may wake up for DRX on durations during the on-period mask.

In some aspects, the UE 1202 may monitor for communication from the base station based on the WUS configuration. The WUS configuration may comprise a plurality of WUS occasions within a DRX on duration of the DRX operation. In some aspects, the WUS configuration may comprise a minimum time gap indicating a minimum gap between a WUS and a time when a DRX on duration timer starts. In some aspects, the configuration for the DRX operation may comprise a plurality of DRX on duration timer start occasions. One or more of the plurality of DRX on duration timer start occasions may start after a start of a corresponding scheduled DRX on duration of the DRX operation. In some aspects, each of the plurality of DRX on duration timer start occasions may be associated with a respective WUS monitoring occasion. In some aspects, the potential DRX on duration may be activated during an existing DRX on duration or a configured DRX on duration. In some aspects, a value of the DRX on duration timer may be configured via radio resource control (RRC) signaling. In some aspects, the value of the DRX on duration timer may be an indicated value. In some aspects, the configuration for the DRX operation may comprise a plurality of search space sets within the DRX on duration and prior to a scheduled arrival time of data. In some aspects, at least one of the plurality of search space sets may be deactivated prior to a subsequent scheduled arrival time of data. In some aspects, a first search space set of the plurality of search space sets may be active at a beginning of the DRX on duration, and a second search space set may be activated if a data set is received within the DRX on duration. A search space that is activated indicates that the search space is monitored by the UE, while a search space that is deactivated indicates that the search space is not being monitored by the UE. The second search space set may be deactivated prior to a next data set being received by the UE. In some aspects, the second search space set may be deactivated based on predefined events. For example, the predefined events may comprise at least switching to a DRX off configuration or an expiration of an inactivity or retransmission timer. In some aspects, the configuration may comprise at least a first search space set active at a beginning of the DRX on duration. In some aspects, the UE may perform sparse monitoring of PDCCH within the first search space set prior to a scheduled burst arrival time. In some aspects, the UE may receive a downlink grant (e.g., 1214) within the first search space set. The UE may receive the downlink grant within the first search space set which may activate a second search space set. In some aspects, while monitoring for communication, the UE may activate the second search space set to perform dense monitoring of PDCCH within the second search space set. The UE may switch from the sparse monitoring of PDCCH to the dense monitoring of PDCCH. In some aspects, activation of the second search space set may be explicitly indicated via DCI. For example, the second search space set may be indicated by a value in the DCI. In some aspects, activation of the second search space set may be implicitly indicated based on reception of the downlink grant. In some aspects, activation of the second search space set occurs after the scheduled burst arrival time. In some aspects, the second search space set is deactivated prior to a next data set being received by the UE. In some aspects, the second search space set is deactivated via DCI. In some aspects, the second search space set is deactivated and the first search space set is activated based on predefined events or an expiration of an activity timer.

In some aspects, the UE 1202 may monitor for the at least one blind decode indication during the DRX on duration. In some aspects, the at least one blind decode indication may be configured based on at least a periodicity, an offset, or a time frequency resource to monitor for the at least one blind decode indication.

In some aspects, the UE 1202 may perform a blind decode operation based on the at least one blind decode indication. In some aspects, the UE may monitor for PDCCH during the blind decode operation based on the at least one blind decode indication. In some aspects, the at least one blind decode indication may inform the UE to perform the blind decode operation.

In some aspects, the UE 1202 may monitor for communication from the base station based on the configuration for SPS occasions. The SPS occasions may be scheduled to correspond with a scheduled arrival time of data.

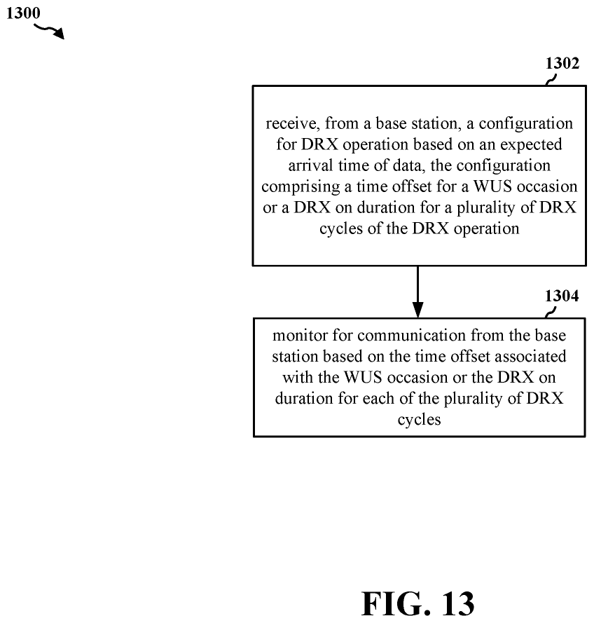

FIG. 13 is a flowchart 1300 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to wake up or have a DRX on duration start time to be offset from a scheduled arrival time of data.

At 1302, the UE may receive a configuration for DRX operation based on a scheduled arrival time of data. For example, 1302 may be performed by configuration component 2040 of apparatus 2002. The UE may receive the configuration from a base station. The configuration for the DRX operation may comprise a time offset for a WUS occasion or a DRX on duration for a plurality of DRX cycles of the DRX operation. In some aspects, a start time for the WUS occasion or the DRX on duration may be delayed based on the time offset. The start time of the WUS occasion or the DRX on duration may be delayed after the scheduled arrival time of the data based on the time offset. In some aspects, the time offset shifts the start time for the WUS occasion or the DRX on duration to minimize jitter at the scheduled arrival time.

At 1304, the UE may monitor for communication from the base station. For example, 1304 may be performed by monitor component 2042 of apparatus 2002. The UE may monitor for communication from the base station based on the time offset associated with the WUS occasion or the DRX on duration for each of the plurality of DRX cycles. In some aspects, the UE does not monitor for PDCCH between the scheduled arrival time and the start time for the WUS occasion or the DRX on duration.

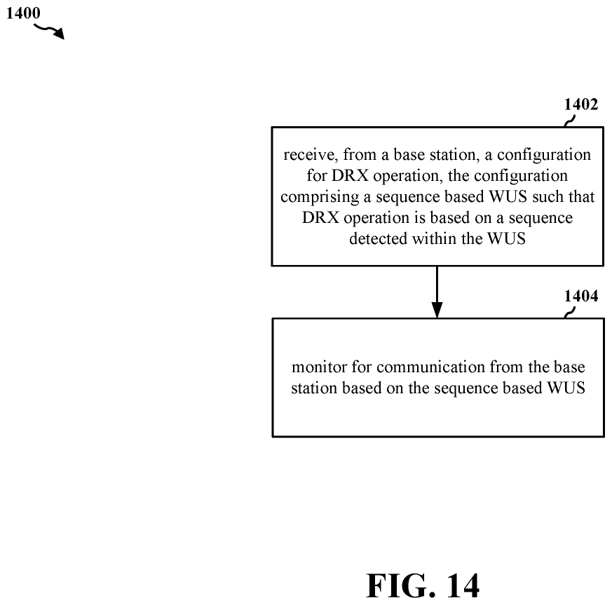

FIG. 14 is a flowchart 1400 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to monitor for downlink data based on a sequenced based WUS.

At 1402, the UE may receive a configuration for DRX operation comprising a sequence based WUS. For example, 1402 may be performed by configuration component 2040 of apparatus 2002. The UE may receive the configuration for DRX operation from a base station. The DRX operation may be based on a sequence detected within the WUS. In some aspects, the sequence based WUS comprises an indication of a narrow bandwidth or wide bandwidth for the DRX operation. The indication may provide a bandwidth switching between the narrow bandwidth or the wide bandwidth. The bandwidth switching may be associated with reception of the sequenced based WUS. In some aspects, the sequence based WUS comprises the indication of the narrow bandwidth. The DRX operation may utilize the narrow bandwidth to monitor for communication from the base station. In some aspects, the sequence based WUS comprises the indication for the wide bandwidth. The DRX operation may utilize the wide bandwidth to monitor for communication from the base station. In some aspects, a DRX on duration of the DRX operation may utilize the wide bandwidth to receive data from the base station.

At 1404, the UE may monitor for communication from the base station based on the sequence based WUS. For example, 1404 may be performed by monitor component 2042 of apparatus 2002. In some aspects, the sequence based WUS may be monitored before each of a plurality of DRX on durations. Each of the plurality of DRX on durations may have a corresponding WUS occasion to monitor for the sequence based WUS. In some aspects, the configuration may comprise a DRX mask indicating a period to monitor for or not to monitor for the sequence based WUS. The period to monitor for or not to monitor for the sequence based WUS of the DRX mask may be in between scheduled arrival times of data. In some aspects, the DRX mask may comprise an off-period mask. The UE may not monitor for the sequence based WUS during the off-period mask. In some aspects, DRX on durations may be skipped during the off-period mask. In some aspects, the off-period mask may be configured by a set of parameters based on a periodicity and offsets for the off-period mask. In some aspects, the DRX mask may comprise an on-period mask. The UE may monitor for the sequence based WUS during the on-period mask. The UE may wake up for DRX on durations during the on-period mask.

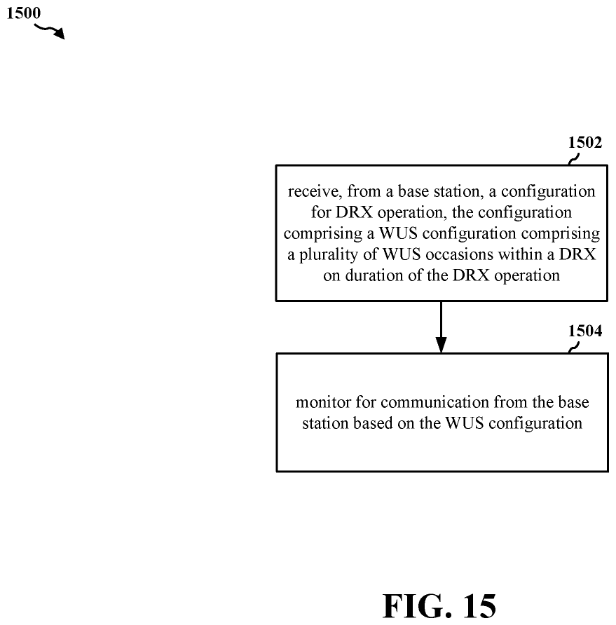

FIG. 15 is a flowchart 1500 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to having multiple WUS within a DRX on duration.

At 1502, the UE may receive a configuration for DRX operation comprising a WUS configuration. For example, 1502 may be performed by configuration component 2040 of apparatus 2002. The UE may receive the configuration for the DRX operation from a base station. The WUS configuration may comprise a plurality of WUS occasions within a DRX on duration of the DRX operation. In some aspects, the WUS configuration may comprise a minimum time gap indicating a minimum gap between a WUS and a time when a DRX on duration timer starts. In some aspects, the configuration for the DRX operation may comprise a plurality of DRX on duration timer start occasions. One or more of the plurality of DRX on duration timer start occasions may start after a start of a corresponding scheduled DRX on duration of the DRX operation. In some aspects, each of the plurality of DRX on duration timer start occasions may be associated with a respective WUS monitoring occasion. In some aspects, the potential DRX on duration may be activated during an existing DRX on duration or a configured DRX on duration. In some aspects, a value of the DRX on duration timer may be configured via RRC signaling. In some aspects, the value of the DRX on duration timer may be an indicated value. In some aspects, the configuration for the DRX operation may comprise a plurality of search space sets within the DRX on duration and prior to a scheduled arrival time of data. In some aspects, at least one of the plurality of search space sets may be deactivated prior to a subsequent scheduled arrival time of data. In some aspects, a first search space set of the plurality of search space sets may be active at a beginning of the DRX on duration, and a second search space set may be activated if a data set is received within the DRX on duration. The second search space set may be deactivated prior to a next data set being received by the UE. In some aspects, the second search space set may be deactivated based on predefined events. For example, the predefined events may comprise at least switching to a DRX off configuration or an expiration of an inactivity or retransmission timer.

At 1504, the UE may monitor for communication from the base station. For example, 1504 may be performed by monitor component 2042 of apparatus 2002. The UE may monitor for communication from the base station based on the WUS configuration.

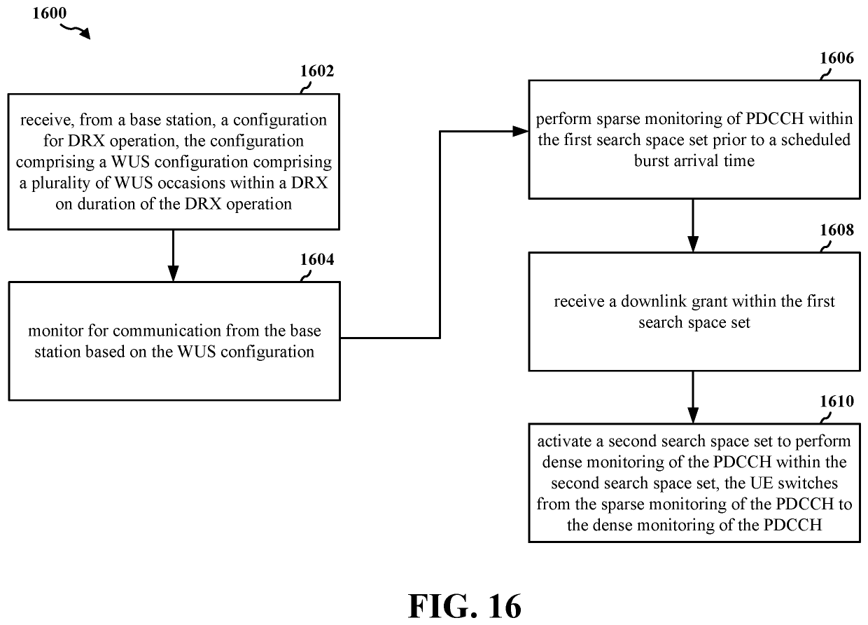

FIG. 16 is a flowchart 1600 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to having multiple WUS within a DRX on duration.

At 1602, the UE may receive a configuration for DRX operation comprising a WUS configuration. For example, 1602 may be performed by configuration component 2040 of apparatus 2002. The UE may receive the configuration for the DRX operation from a base station. The WUS configuration may comprise a plurality of WUS occasions within a DRX on duration of the DRX operation. In some aspects, the WUS configuration may comprise a minimum time gap indicating a minimum gap between a WUS and a time when a DRX on duration timer starts. In some aspects, the configuration for the DRX operation may comprise a plurality of DRX on duration timer start occasions. One or more of the plurality of DRX on duration timer start occasions may start after a start of a corresponding scheduled DRX on duration of the DRX operation. In some aspects, each of the plurality of DRX on duration timer start occasions may be associated with a respective WUS monitoring occasion. In some aspects, the potential DRX on duration may be activated during an existing DRX on duration or a configured DRX on duration. In some aspects, a value of the DRX on duration timer may be configured via RRC signaling. In some aspects, the value of the DRX on duration timer may be an indicated value. In some aspects, the configuration for the DRX operation may comprise a plurality of search space sets within the DRX on duration and prior to a scheduled arrival time of data. In some aspects, at least one of the plurality of search space sets may be deactivated prior to a subsequent scheduled arrival time of data. In some aspects, a first search space set of the plurality of search space sets may be active at a beginning of the DRX on duration, and a second search space set may be activated if a data set is received within the DRX on duration. The second search space set may be deactivated prior to a next data set being received by the UE. In some aspects, the second search space set may be deactivated based on predefined events. For example, the predefined events may comprise at least switching to a DRX off configuration or an expiration of an inactivity or retransmission timer.

At 1604, the UE may monitor for communication from the base station. For example, 1604 may be performed by monitor component 2042 of apparatus 2002. The UE may monitor for communication from the base station based on the WUS configuration.

At 1606, the UE may perform sparse monitoring of PDCCH within the first search space set prior to a scheduled burst arrival time. For example, 1606 may be performed by monitor component 2042 of apparatus 2002. In some aspects, the configuration may comprise at least a first search space set active at a beginning of the DRX on duration.

At 1608, the UE may receive a downlink grant within the first search space set. For example, 1608 may be performed by reception component 2030 of apparatus 2002. The UE may receive the downlink grant within the first search space set which may activate a second search space set.

At 1610, the UE may activate the second search space set to perform dense monitoring of PDCCH within the second search space set. For example, 1610 may be performed by monitor component 2042 of apparatus 2002. The UE may switch from the sparse monitoring of PDCCH to the dense monitoring of PDCCH. In some aspects, activation of the second search space set may be explicitly indicated via DCI. In some aspects, activation of the second search space set may be implicitly indicated based on reception of the downlink grant. In some aspects, activation of the second search space set occurs after the scheduled burst arrival time. In some aspects, the second search space set is deactivated prior to a next data set being received by the UE. In some aspects, the second search space set is deactivated via DCI. In some aspects, the second search space set is deactivated and the first search space set is activated based on predefined events or an expiration of an activity timer.

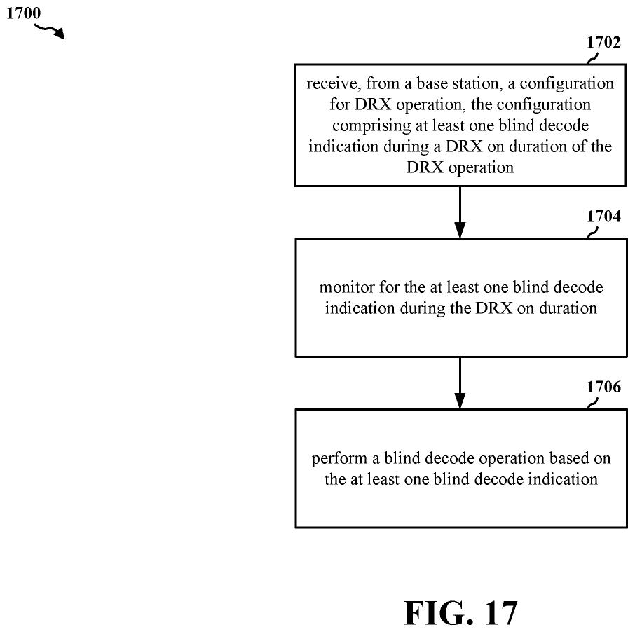

FIG. 17 is a flowchart 1700 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to perform blind decoding based on a blind decode indicator.

At 1702, the UE may receive a configuration for DRX operation comprising at least one blind decode indication. For example, 1702 may be performed by configuration component 2040 of apparatus 2002. The UE may receive the configuration for DRX operation from a base station. The at least one blind decode indication may be during a DRX on duration of the DRX operation.

At 1704, the UE may monitor for the at least one blind decode indication during the DRX on duration. For example, 1704 may be performed by monitor component 2042 of apparatus 2002. In some aspects, the at least one blind decode indication may be configured based on at least a periodicity, an offset, or a time frequency resource to monitor for the at least one blind decode indication.

At 1706, the UE may perform a blind decode operation based on the at least one blind decode indication. For example, 1706 may be performed by decode component 2044 of apparatus 2002. In some aspects, the UE may monitor for PDCCH during the blind decode operation based on the at least one blind decode indication. In some aspects, the at least one blind decode indication may inform the UE to perform the blind decode operation.

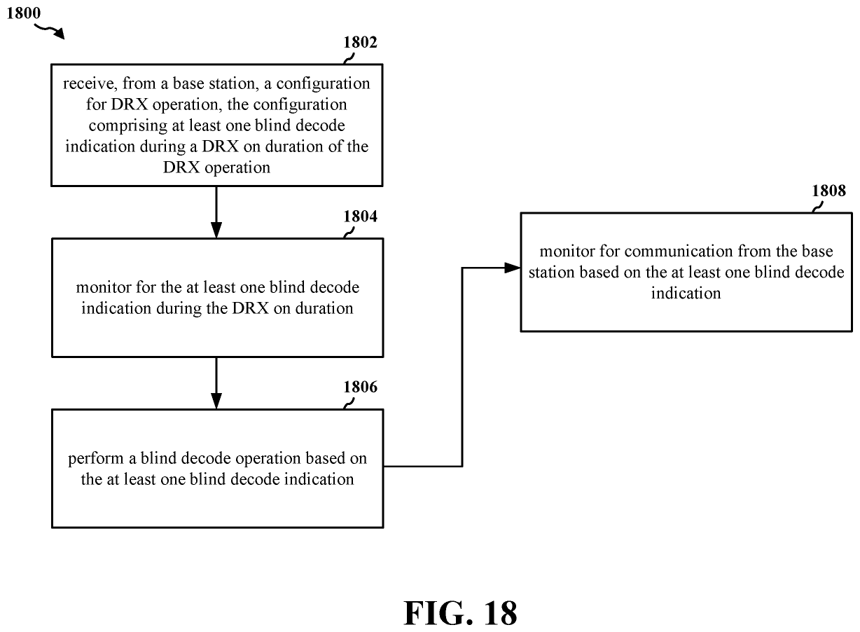

FIG. 18 is a flowchart 1800 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to perform blind decoding based on a blind decode indicator.

At 1802, the UE may receive a configuration for DRX operation comprising at least one blind decode indication. For example, 1802 may be performed by configuration component 2040 of apparatus 2002. The UE may receive the configuration for DRX operation from a base station. The at least one blind decode indication may be during a DRX on duration of the DRX operation.

At 1804, the UE may monitor for the at least one blind decode indication during the DRX on duration. For example, 1804 may be performed by monitor component 2042 of apparatus 2002. In some aspects, the at least one blind decode indication may be configured based on at least a periodicity, an offset, or a time frequency resource to monitor for the at least one blind decode indication.

At 1806, the UE may perform a blind decode operation based on the at least one blind decode indication. For example, 1806 may be performed by decode component 2044 of apparatus 2002. In some aspects, the UE may monitor for PDCCH during the blind decode operation based on the at least one blind decode indication. In some aspects, the at least one blind decode indication may inform the UE to perform the blind decode operation.

At 1808, the UE may monitor for communication from the base station. For example, 1808 may be performed by monitor component 2042 of apparatus 2002. The UE may monitor for communication from the base station based on the at least one blind decode indication.

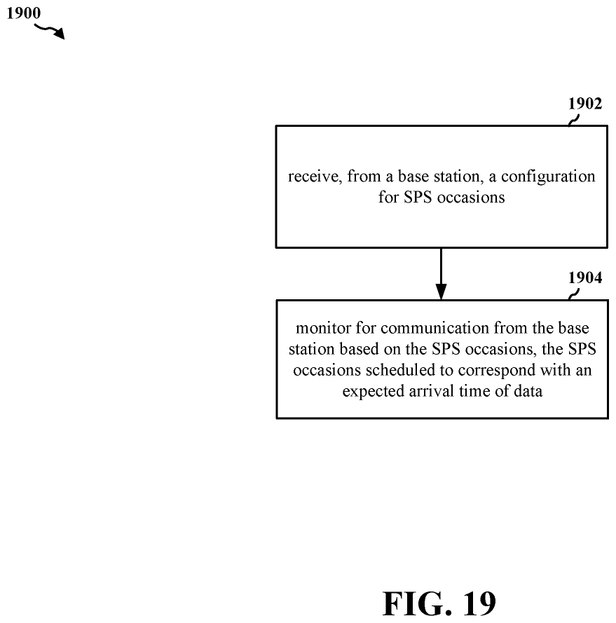

FIG. 19 is a flowchart 1900 of a method of wireless communication. The method may be performed by a UE or a component of a UE (e.g., the UE 104; the apparatus 2002; the cellular baseband processor 2004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to conditionally monitor for data during SPS occasions.

At 1902, the UE may receive a configuration comprising a configuration for SPS occasions. For example, 1902 may be performed by configuration component 2040 of apparatus 2002. The UE may receive the configuration comprising the configuration for the SPS occasions from a base station. In some aspects, the SPS occasions may comprise a first SPS occasion and a second SPS occasion. The UE may not wake up during the second SPS occasion if data is received during the first SPS occasion. The first SPS occasion may correspond with the scheduled arrival time of the data. In some aspects, the UE may wake up during the second SPS occasion if data is not received during the first SPS occasion. In some aspects, the first SPS occasion may correspond with the scheduled arrival time of the data and the second SPS occasion may be after the scheduled arrival time of the data but prior to a subsequent arrival time of data.

At 1904, the UE may monitor for communication from the base station based on the SPS occasions. For example, 1904 may be performed by monitor component 2042 of apparatus 2002. The SPS occasions may be scheduled to correspond with a scheduled arrival time of data.

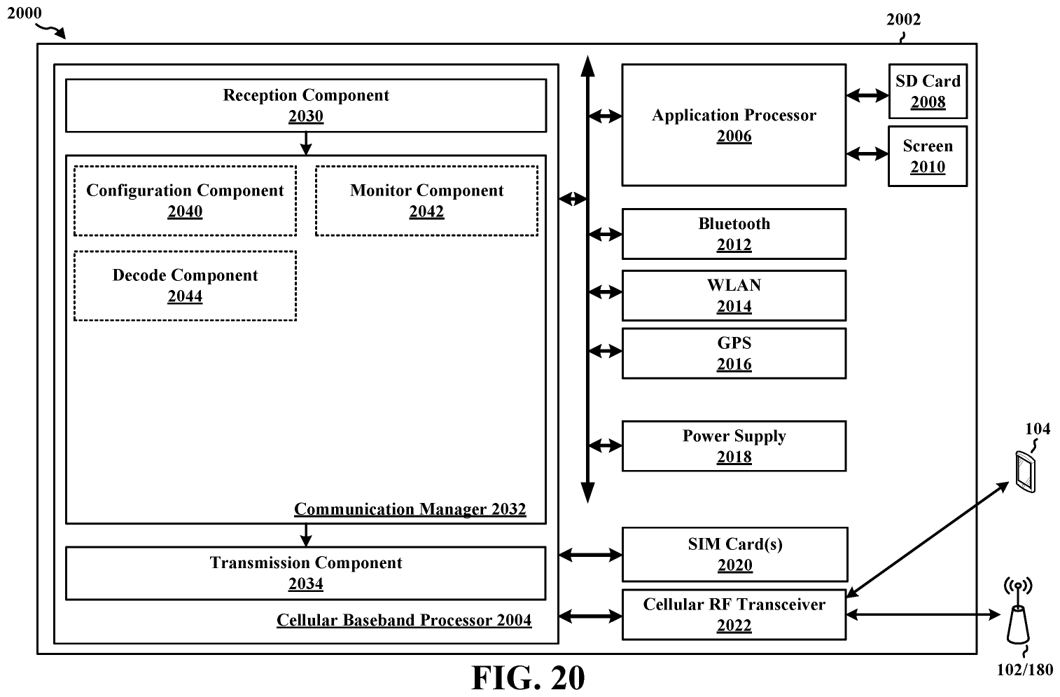

FIG. 20 is a diagram 2000 illustrating an example of a hardware implementation for an apparatus 2002. The apparatus 2002 is a UE and includes a cellular baseband processor 2004 (also referred to as a modem) coupled to a cellular RF transceiver 2022 and one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, and a power supply 2018. The cellular baseband processor 2004 communicates through the cellular RF transceiver 2022 with the UE 104 and/or BS 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the UE 350 and may include the memory 360 and/or at least one of the TX processor 368, the RX processor 356, and the controller/processor 359. In one configuration, the apparatus 2002 may be a modem chip and include just the cellular baseband processor 2004, and in another configuration, the apparatus 2002 may be the entire UE (e.g., see 350 of FIG. 3) and include the aforediscussed additional modules of the apparatus 2002.

The communication manager 2032 includes a configuration component 2040 that is configured to receive a configuration for DRX operation based on a scheduled arrival time of data, e.g., as described in connection with 1302 of FIG. 13. The configuration component 2040 may be configured to receive a configuration for DRX operation comprising a sequence based WUS, e.g., as described in connection with 1402 of FIG. 14. The configuration component 2040 may be configured to receive a configuration for DRX operation comprising a WUS configuration, e.g., as described in connection with 1502 of FIG. 15 or 1602 of FIG. 16. The configuration component 2040 may be configured to receive a configuration for DRX operation comprising at least one blind decode indication, e.g., as described in connection with 1702 of FIG. 17 or 1802 of FIG. 18. The configuration component 2040 may be configured to receive a configuration comprising a configuration for SPS occasions, e.g., as described in connection with 1902 of FIG. 19. The communication manager 2032 further includes a monitor component 2042 that is configured to monitor for communication from the base station, e.g., as described in connection with 1304 of FIG. 13. The monitor component 2042 may be configured to monitor for communication from the base station based on the sequence based WUS, e.g., as described in connection with 1404 of FIG. 14. The monitor component 2042 may be configured to monitor for communication from the base station, e.g., as described in connection with 1504 of FIG. 15 or 1604 of FIG. 16. The monitor component 2042 may be configured to perform sparse monitoring of PDCCH within the first search space set prior to a scheduled burst arrival time, e.g., as described in connection with 1606 of FIG. 16. The reception component 2030 may be configured to receive a downlink grant within the first search space set, e.g., as described in connection with 1608 of FIG. 16. The monitor component 2042 may be configured to activate the second search space set to perform dense monitoring of PDCCH within the second search space set, e.g., as described in connection with 1610 of FIG. 16. The monitor component 2042 may be configured to monitor for the at least one blind decode indication during the DRX on duration, e.g., as described in connection with 1704 of FIG. 17 or 1804 of FIG. 18. The monitor component 2042 may be configured to monitor for communication from the base station, e.g., as described in connection with 1808 of FIG. 18. The monitor component 2042 may be configured to monitor for communication from the base station based on the SPS occasions, e.g., as described in connection with 1904 of FIG. 19. The communication manager 2032 further includes a decode component 2044 that is configured to perform a blind decode operation based on the at least one blind decode indication, e.g., as described in connection with 1706 of FIG. 17 or 1806 of FIG. 18.

The apparatus may include additional components that perform each of the blocks of the algorithm in the aforementioned flowcharts of FIGS. 13-19. As such, each block in the aforementioned flowcharts of FIGS. 13-19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the cellular baseband processor 2004, includes means for receiving a configuration from a base station comprising a configuration for DRX operation based on a scheduled arrival time of data. The configuration comprises a time offset for a WUS occasion or a DRX on duration for a plurality of DRX cycles of the DRX operation. The apparatus includes means for monitoring for communication from the base station based on the time offset associated with the WUS occasion or the DRX on duration for each of the plurality of DRX cycle. The apparatus includes means for receiving a configuration from a base station comprising a configuration for DRX operation. The configuration comprises a sequence based WUS such that DRX operation is based on a sequence detected within the WUS. The apparatus includes means for monitoring for communication from the base station based on the sequence based WUS. The apparatus includes means for receiving a configuration from a base station comprising a configuration for DRX operation. The configuration comprises a WUS configuration comprising a plurality of WUS occasions within a DRX on duration of the DRX operation. The apparatus includes means for monitoring for communication from the base station based on the WUS configuration. The apparatus further includes means for performing sparse monitoring of PDCCH within the first search space set prior to a scheduled burst arrival time. The apparatus further includes means for activating a second search space set to perform dense monitoring of PDCCH within the second search space set. The UE switches from the sparse monitoring of PDCCH to the dense monitoring of PDCCH. The apparatus further includes means for receiving a downlink grant within the first search space set. The apparatus includes means for receiving a configuration from a base station comprising a configuration for DRX operation. The configuration comprises at least one blind decode indication during a DRX on duration of the DRX operation. The apparatus includes means for monitoring for the at least one blind decode indication during the DRX on duration. The apparatus includes means for performing a blind decode operation based on the at least one blind decode indication. The apparatus further includes means for monitoring for communication from the base station based on the at least one blind decode indication. The apparatus includes means for receiving a configuration from a base station comprising a configuration for SPS occasions. The apparatus includes means for monitoring for communication from the base station based on the SPS occasions, wherein the SPS occasions are scheduled to correspond with a scheduled arrival time of data. The aforementioned means may be one or more of the aforementioned components of the apparatus 2002 configured to perform the functions recited by the aforementioned means. As described supra, the apparatus 2002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

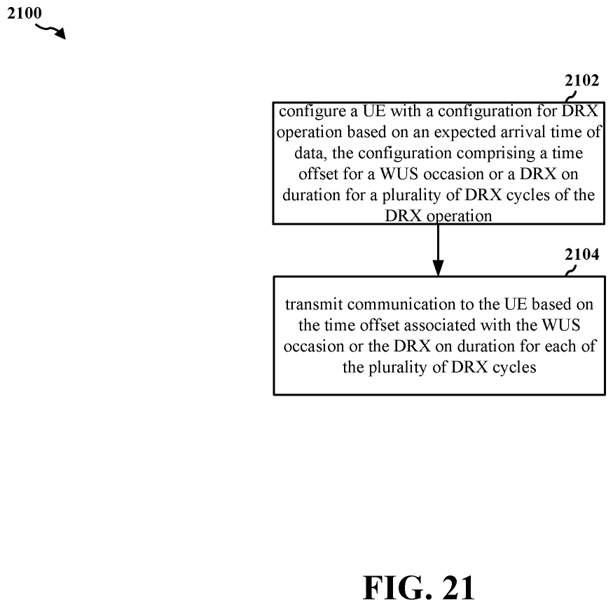

FIG. 21 is a flowchart 2100 of a method of wireless communication. The method may be performed by a base station or a component of a base station (e.g., the base station 102/180; the apparatus 2702; the baseband unit 2704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to wake up or have a DRX on duration start time offset from a scheduled arrival time of data.

At 2102, the base station may configure a configuration for DRX operation based on a scheduled arrival time of data. For example, 2102 may be performed by configuration component 2740 of apparatus 2702. The base station may configure a UE with the configuration for the DRX operation based on the scheduled arrival time of data. The configuration for the DRX operation may comprise a time offset for a WUS occasion or a DRX on duration for a plurality of DRX cycles of the DRX operation. In some aspects, a start time for the WUS occasion or the DRX on duration may be delayed based on the time offset. The start time of the WUS occasion or the DRX on duration may be delayed after the scheduled arrival time of the data based on the time offset. In some aspects, the time offset shifts the start time for the WUS occasion or the DRX on duration to minimize jitter at the scheduled arrival time.

At 2104, the base station may transmit communication to the UE. For example, 2104 may be performed by transmission component 2734 of apparatus 2702. The base station may transmit communication to the UE based on the time offset associated with the WUS occasion or the DRX on duration for each of the plurality of DRX cycles. In some aspects, the UE does not monitor for PDCCH between the scheduled arrival time and the start time for the WUS occasion or the DRX on duration.

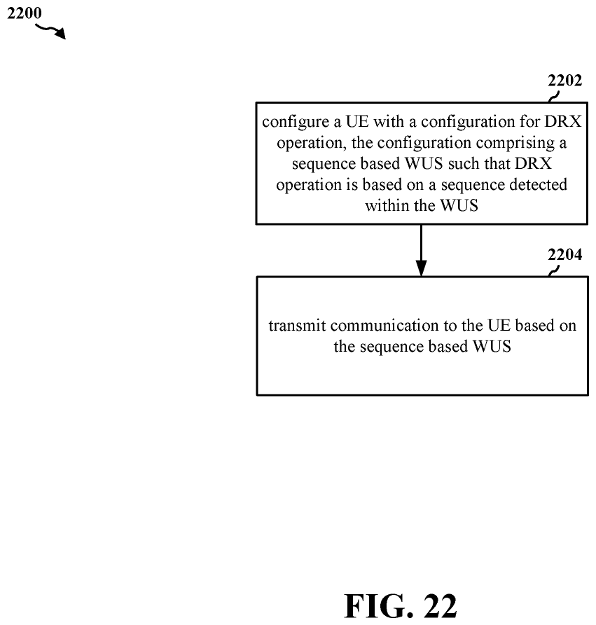

FIG. 22 is a flowchart 2200 of a method of wireless communication. The method may be performed by a base station or a component of a base station (e.g., the base station 102/180; the apparatus 2702; the baseband unit 2704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to monitor for downlink data based on a sequenced based WUS.

At 2202, the base station may configure a configuration for DRX operation comprising a sequence based WUS. For example, 2202 may be performed by configuration component 2740 of apparatus 2702. The base station may configure a UE with the configuration for DRX operation comprising the sequence based WUS. The DRX operation may be based on a sequence detected within the WUS. In some aspects, the sequence based WUS comprises an indication of a narrow bandwidth or wide bandwidth for the DRX operation. The indication may provide a bandwidth switching between the narrow bandwidth or the wide bandwidth. The bandwidth switching may be associated with reception of the sequenced based WUS by the UE. In some aspects, the sequence based WUS comprises the indication of the narrow bandwidth. The UE may operate the DRX operation in the narrow bandwidth to monitor for communication from the base station. In some aspects, the sequence based WUS comprises the indication for the wide bandwidth. The UE may operate the DRX operation in the wide bandwidth to monitor for communication from the base station. In some aspects, the UE in a DRX on duration of the DRX operation may utilize the wide bandwidth to receive data from the base station.

At 2204, the base station may transmit communication to the UE based on the sequence based WUS. For example, 2204 may be performed by transmission component 2734 of apparatus 2702. In some aspects, the sequence based WUS may be transmitted before each of a plurality of DRX on durations. Each of the plurality of DRX on durations may have a corresponding WUS occasion transmitted for the sequence based WUS. In some aspects, the configuration may comprise a DRX mask indicating a period for the UE to monitor for or not to monitor for the sequence based WUS. The period for the UE to monitor for or not to monitor for the sequence based WUS of the DRX mask may be in between scheduled arrival times of data. In some aspects, the DRX mask may comprise an off-period mask. The UE may not monitor for the sequence based WUS during the off-period mask. In some aspects, the off-period mask may be configured by a set of parameters based on a periodicity and offsets for the off-period mask. In some aspects, the DRX mask may comprise an on-period mask. The UE may monitor for the sequence based WUS during the on-period mask. The UE may wake up for DRX on durations during the on-period mask.

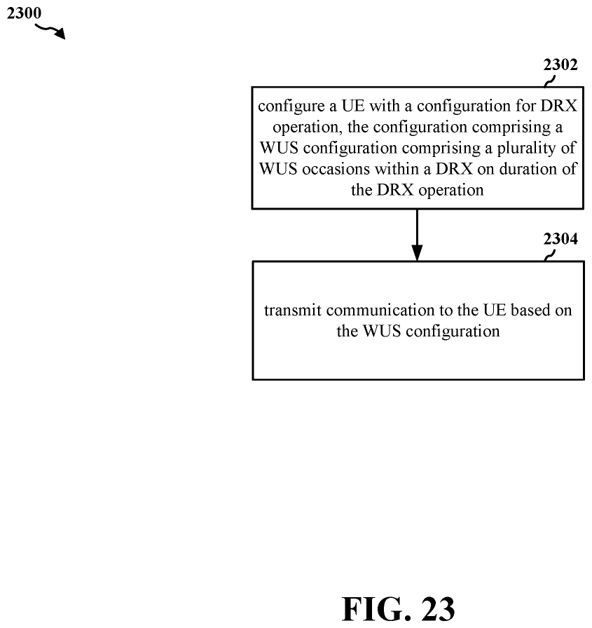

FIG. 23 is a flowchart 2300 of a method of wireless communication. The method may be performed by a base station or a component of a base station (e.g., the base station 102/180; the apparatus 2702; the baseband unit 2704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE with a configuration having multiple WUS within a DRX on duration.

At 2302, the base station may configure a configuration for DRX operation comprising a WUS configuration. For example, 2302 may be performed by configuration component 2740 of apparatus 2702. The base station may configure a UE with the configuration for DRX operation comprising the WUS configuration. The WUS configuration may comprise a plurality of WUS occasions within a DRX on duration of the DRX operation. In some aspects, the WUS configuration may comprise a minimum time gap indicating a minimum gap between a WUS and a time when a DRX on duration timer starts. In some aspects, the configuration for the DRX operation may comprise a plurality of DRX on duration timer start occasions. One or more of the plurality of DRX on duration timer start occasions may start after a start of a corresponding scheduled DRX on duration of the DRX operation. In some aspects, each of the plurality of DRX on duration timer start occasions may be associated with a respective WUS monitoring occasion. In some aspects, the potential DRX on duration may be activated during an existing DRX on duration or a configured DRX on duration. In some aspects, a value of the DRX on duration timer may be configured via RRC signaling. In some aspects, the value of the DRX on duration timer may be an indicated value. For example, the value of the DRX on duration timer may be indicated in the configuration for the DRX operation. In some aspects, the configuration for the DRX operation may comprise a plurality of search space sets within the DRX on duration and prior to a scheduled arrival time of data. In some aspects, at least one of the plurality of search space sets may be deactivated prior to a subsequent scheduled arrival time of data. In some aspects, a first search space set of the plurality of search space sets may be active at a beginning of the DRX on duration, and a second search space set may be activated if a data set is received by the UE within the DRX on duration. The second search space set may be deactivated prior to a next data set being received by the UE. In some aspects, the second search space set may be deactivated based on predefined events. For example, the predefined events may comprise at least switching to a DRX off configuration or an expiration of an inactivity or retransmission timer.

At 2304, the base station may transmit communication to the UE. For example, 2304 may be performed by transmission component 2734 of apparatus 2702. The base station may transmit communication to the UE based on the WUS configuration.

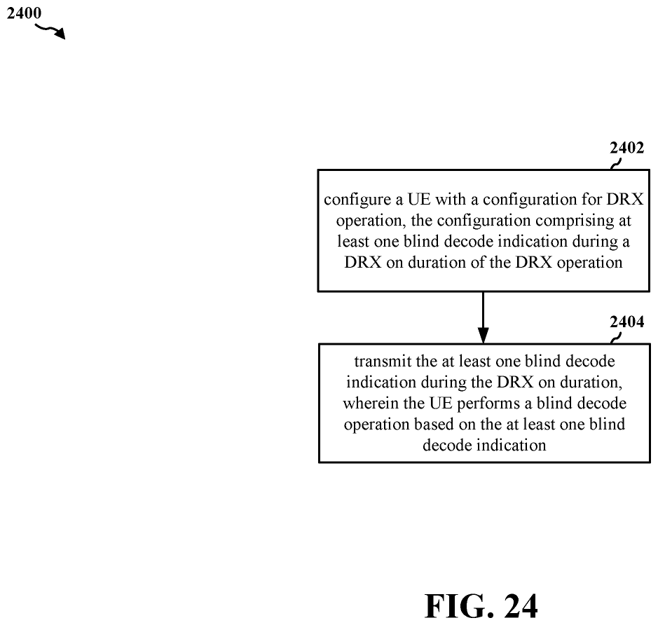

FIG. 24 is a flowchart 2400 of a method of wireless communication. The method may be performed by a base station or a component of a base station (e.g., the base station 102/180; the apparatus 2702; the baseband unit 2704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to perform blind decoding based on a blind decode indicator.

At 2402, the base station may configure a configuration for DRX operation comprising at least one blind decode indication. For example, 2402 may be performed by decode component 2742 of apparatus 2702. The base station may configure a UE with the configuration for DRX operation comprising the at least one blind decode indication. The at least one blind decode indication may be during a DRX on duration of the DRX operation. In some aspects, the at least one blind decode indication may be configured based on at least a periodicity, an offset, or a time frequency resource to monitor for the at least one blind decode indication.

At 2404, the base station may transmit the at least one blind decode indication during the DRX on duration. For example, 2404 may be performed by transmission component 2734 of apparatus 2702. The UE may perform a blind decode operation based on the at least one blind decode indication. In some aspects, the base station may transmit PDCCH during the blind decode operation based on the at least one blind decode indication. In some aspects, the at least one blind decode indication may inform the UE to perform the blind decode operation.

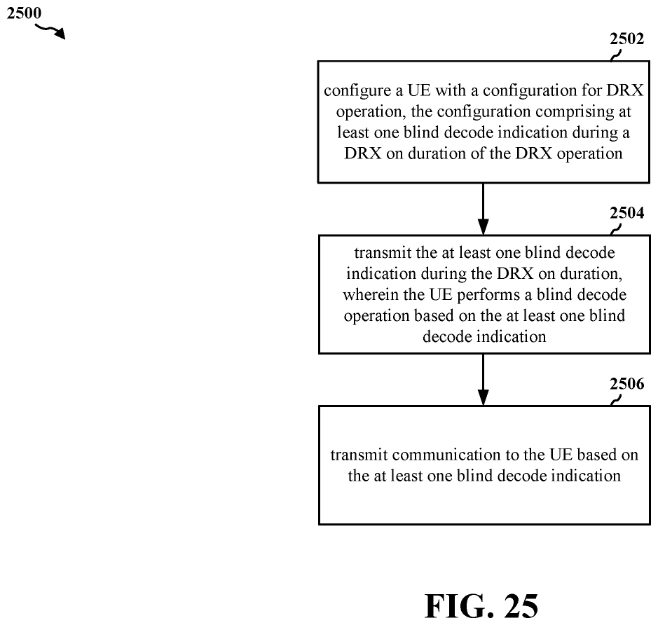

FIG. 25 is a flowchart 2500 of a method of wireless communication. The method may be performed by a base station or a component of a base station (e.g., the base station 102/180; the apparatus 2702; the baseband unit 2704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to perform blind decoding based on a blind decode indicator.

At 2502, the base station may configure a configuration for DRX operation comprising at least one blind decode indication. For example, 2502 may be performed by decode component 2742 of apparatus 2702. The base station may configure a UE with the configuration for DRX operation comprising the at least one blind decode indication. The at least one blind decode indication may be during a DRX on duration of the DRX operation. In some aspects, the at least one blind decode indication may be configured based on at least a periodicity, an offset, or a time frequency resource to monitor for the at least one blind decode indication.

At 2504, the base station may transmit the at least one blind decode indication during the DRX on duration. For example, 2504 may be performed by transmission component 2734 of apparatus 2702. The UE may perform a blind decode operation based on the at least one blind decode indication. In some aspects, the base station may transmit PDCCH during the blind decode operation based on the at least one blind decode indication. In some aspects, the at least one blind decode indication may inform the UE to perform the blind decode operation.

At 2506, the base station may transmit communication to the UE. For example, 2506 may be performed by transmission component 2734 of apparatus 2702. The base station may transmit the communication to the UE based on the at least one blind decode indication.

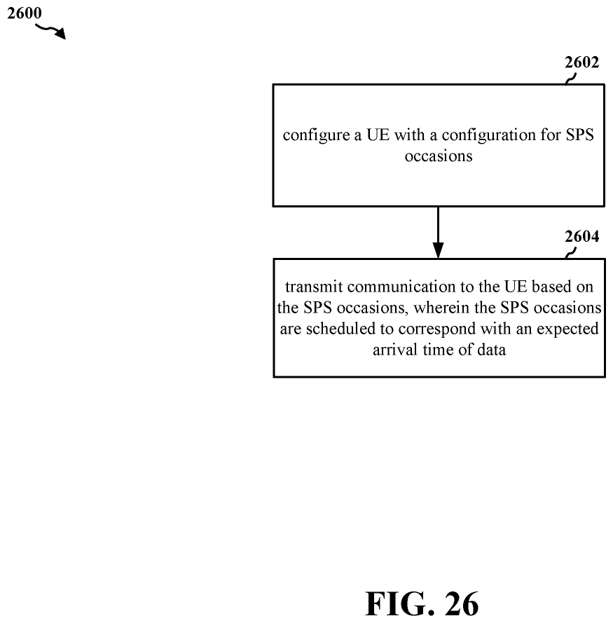

FIG. 26 is a flowchart 2600 of a method of wireless communication. The method may be performed by a base station or a component of a base station (e.g., the base station 102/180; the apparatus 2702; the baseband unit 2704, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to conditionally monitor for data during SPS occasions.

At 2602, the base station may configure a configuration comprising a configuration for SPS occasions. For example, 2602 may be performed by configuration component 2740 of apparatus 2702. The base station may configure a UE with the configuration comprising the configuration for the SPS occasions. In some aspects, the SPS occasions may comprise a first SPS occasion and a second SPS occasion. The UE may not wake up during the second SPS occasion if data is transmitted by the base station and received by the UE during the first SPS occasion. The first SPS occasion may correspond with the scheduled arrival time of the data. In some aspects, the UE may wake up during the second SPS occasion if data is not transmitted by the base station and/or not received by the UE during the first SPS occasion. In some aspects, the first SPS occasion may correspond with the scheduled arrival time of the data and the second SPS occasion may be after the scheduled arrival time of the data but prior to a subsequent arrival time of data.

At 2604, the base station may transmit communication to the UE based on the SPS occasions. For example, 2604 may be performed by transmission component 2734 of apparatus 2702. The SPS occasions may be scheduled to correspond with a scheduled arrival time of data.

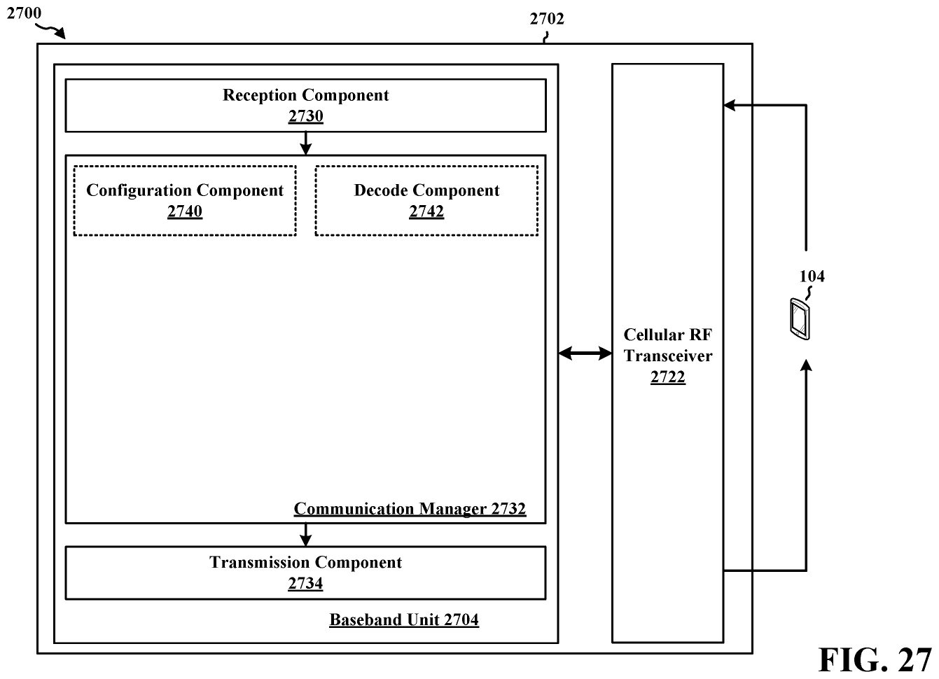

FIG. 27 is a diagram 2700 illustrating an example of a hardware implementation for an apparatus 2702. The apparatus 2702 is a BS and includes a baseband unit 2704. The baseband unit 2704 may communicate through a cellular RF transceiver 2722 with the UE 104. The baseband unit 2704 may include a computer-readable medium/memory. The baseband unit 2704 is responsible for general processing, including the execution of software stored on the computer-readable medium/memory. The software, when executed by the baseband unit 2704, causes the baseband unit 2704 to perform the various functions described supra. The computer-readable medium/memory may also be used for storing data that is manipulated by the baseband unit 2704 when executing software. The baseband unit 2704 further includes a reception component 2730, a communication manager 2732, and a transmission component 2734. The communication manager 2732 includes the one or more illustrated components. The components within the communication manager 2732 may be stored in the computer-readable medium/memory and/or configured as hardware within the baseband unit 2704. The baseband unit 2704 may be a component of the BS 310 and may include the memory 376 and/or at least one of the TX processor 316, the RX processor 370, and the controller/processor 375.

The communication manager 2732 includes a configuration component 2740 that may configure a configuration for DRX operation based on a scheduled arrival time of data, e.g., as described in connection with 2102 of FIG. 21. The configuration component 2740 may configure a configuration for DRX operation comprising a sequence based WUS, e.g., as described in connection with 2202 of FIG. 22. The configuration component 2740 may configure a configuration for DRX operation comprising a WUS configuration, e.g., as described in connection with 2302 of FIG. 23. The configuration component 2740 may configure a configuration for DRX operation comprising at least one blind decode indication, e.g., as described in connection with 2402 of FIG. 24 or 2502 of FIG. 25. The configuration component 2740 may configure a configuration comprising a configuration for SPS occasions, e.g., as described in connection with 2602 of FIG. 26. The transmission component 2734 may transmit communication to the UE, e.g., as described in connection with 2104 of FIG. 21. The transmission component 2734 may transmit communication to the UE based on the sequence based WUS, e.g., as described in connection with 2204 of FIG. 22. The transmission component 2734 may transmit communication to the UE, e.g., as described in connection with 2304 of FIG. 23. The transmission component 2734 may transmit communication to the UE, e.g., as described in connection with 2506 of FIG. 25. The transmission component 2734 may transmit communication to the UE based on the SPS occasions, e.g., as described in connection with 2604 of FIG. 26. The communication manager 2732 further includes a decode component 2742 that may transmit the at least one blind decode indication during the DRX on duration, e.g., as described in connection with 2404 of FIG. 24 or 2504 of FIG. 25.

The apparatus may include additional components that perform each of the blocks of the algorithm in the aforementioned flowcharts of FIGS. 21-26. As such, each block in the aforementioned flowcharts of FIGS. 21-26 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2702, and in particular the baseband unit 2704, includes means for configuring a UE with a configuration for DRX operation based on a scheduled arrival time of data, wherein the configuration comprises a time offset for a WUS occasion or a DRX on duration for a plurality of DRX cycles of the DRX operation. The apparatus includes means for transmitting communication to the UE based on the time offset associated with the WUS occasion or the DRX on duration for each of the plurality of DRX cycles. The apparatus includes means for configuring a UE with a configuration for DRX operation, wherein the configuration comprises a sequence based WUS such that DRX operation is based on a sequence detected within the WUS. The apparatus includes means for transmitting communication to the UE based on the sequence based WUS. The apparatus includes means for configuring a UE with a configuration for DRX operation, wherein the configuration comprises a WUS configuration comprising a plurality of WUS occasions within a DRX on duration of the DRX operation. The apparatus includes means for transmitting communication to the UE based on the WUS configuration. The apparatus includes means for configuring a UE with a configuration for DRX operation, wherein the configuration comprises at least one blind decode indication during a DRX on duration of the DRX operation. The apparatus includes means for transmitting the at least one blind decode indication during the DRX on duration, wherein the UE performs a blind decode operation based on the at least one blind decode indication. The apparatus further includes means for transmitting communication to the UE based on the at least one blind decode indication. The apparatus includes means for configuring a UE with a configuration for SPS occasions. The apparatus includes means for transmitting communication to the UE based on the SPS occasions, wherein the SPS occasions are scheduled to correspond with a scheduled arrival time of data. The aforementioned means may be one or more of the aforementioned components of the apparatus 2702 configured to perform the functions recited by the aforementioned means. As described supra, the apparatus 2702 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Aspect 1 is a method of wireless communication of a UE comprising receiving a configuration from a base station comprising a configuration for DRX operation based on a scheduled arrival time of data, wherein the configuration comprises a time offset for a WUS occasion or a DRX on duration for a plurality of DRX cycles of the DRX operation; and monitoring for communication from the base station based on the time offset associated with the WUS occasion or the DRX on duration for each of the plurality of DRX cycles.

In Aspect 2, the method of Aspect 1 further includes that a start time for the WUS occasion or the DRX on duration is delayed based on the time offset.

In Aspect 3, the method of Aspect 1 or 2 further includes that the start time of the WUS occasion or the DRX on duration is delayed after the scheduled arrival time of the data based on the time offset.

In Aspect 4, the method of any of Aspects 1-3 further includes that the UE does not monitor for PDCCH between the scheduled arrival time and the start time for the WUS occasion or the DRX on duration.

In Aspect 5, the method of any of Aspects 1-4 further includes that time offset shifts the start time for the WUS occasion or the DRX on duration to minimize jitter at the scheduled arrival time.

Aspect 6 is a device including one or more processors and one or more memories in electronic communication with the one or more processors and storing instructions executable by the one or more processors to cause the device to implement a method as in any of Aspects 1-5.

Aspect 7 is a system or apparatus including means for implementing a method or realizing an apparatus as in any of Aspects 1-5.

Aspect 8 is a non-transitory computer readable storage medium storing instructions executable by one or more processors to cause the one or more processors to implement a method as in any of Aspect 1-5.

Aspect 9 is a method of wireless communication of a UE comprising receiving a configuration from a base station comprising a configuration for DRX operation, wherein the configuration comprises a sequence based WUS such that DRX operation is based on a sequence detected within the WUS; and monitoring for communication from the base station based on the sequence based WUS.

In Aspect 10, the method of Aspect 9 further includes that the sequence based WUS is monitored before each of a plurality of DRX on durations.

In Aspect 11, the method of Aspect 9 or 10 further includes that each of the plurality of DRX on durations has a corresponding WUS occasion to monitor for the sequence based WUS.

In Aspect 12, the method of any of Aspects 9-11 further includes that the sequence based WUS comprises an indication of a narrow bandwidth or wide bandwidth for the DRX operation.

In Aspect 13, the method of any of Aspects 9-12 further includes that the indication provides a bandwidth switching between the narrow bandwidth or the wide bandwidth.

In Aspect 14, the method of any of Aspects 9-13 further includes that the bandwidth switching is associated with reception of the sequenced based WUS.

In Aspect 15, the method of any of Aspects 9-14 further includes that the sequence based WUS comprises the indication of the narrow bandwidth, wherein the DRX operation utilizes the narrow bandwidth to monitor for communication from the base station.

In Aspect 16, the method of any of Aspects 9-15 further includes that the sequence based WUS comprises the indication for the wide bandwidth, wherein the DRX operation utilizes the wide bandwidth to monitor for communication from the base station.

In Aspect 17, the method of any of Aspects 9-16 further includes that a DRX on duration of the DRX operation utilizes the wide bandwidth to receive data from the base station.

In Aspect 18, the method of any of Aspects 9-17 further includes that the configuration comprises a DRX mask indicating a period to monitor for or not to monitor for the sequence based WUS.

In Aspect 19, the method of any of Aspects 9-18 further includes that the period to monitor for or not to monitor for the sequence based WUS of the DRX mask is in between scheduled arrival times of data.

In Aspect 20, the method of any of Aspects 9-19 further includes that the DRX mask comprises an off-period mask, wherein the UE does not monitor for the sequence based WUS during the off-period mask.

In Aspect 21, the method of any of Aspects 9-20 further includes that DRX on durations are skipped during the off-period mask.

In Aspect 22, the method of any of Aspects 9-21 further includes that the off-period mask is configured by a set of parameters based on a periodicity and offsets for the off-period mask.

In Aspect 23, the method of any of Aspects 9-22 further includes that the DRX mask comprises an on-period mask, wherein the UE monitors for the sequence based WUS during the on-period mask.

In Aspect 24, the method of any of Aspects 9-23 further includes that wherein the UE wakes up for DRX on durations during the on-period mask.

Aspect 25 is a device including one or more processors and one or more memories in electronic communication with the one or more processors and storing instructions executable by the one or more processors to cause the device to implement a method as in any of Aspects 9-24.

Aspect 26 is a system or apparatus including means for implementing a method or realizing an apparatus as in any of Aspects 9-24.

Aspect 27 is a non-transitory computer readable storage medium storing instructions executable by one or more processors to cause the one or more processors to implement a method as in any of Aspect 9-24.

Aspect 28 is a method of wireless communication at a UE comprising receiving, from a base station, a configuration for DRX operation, wherein the configuration comprises a WUS configuration comprising a plurality of WUS occasions within a DRX on duration of the DRX operation; and monitoring for communication from the base station based on the WUS configuration.

In Aspect 29, the method of Aspect 28 further includes that the WUS configuration comprises a minimum time gap indicating a minimum gap between a WUS and a time when a DRX on duration timer starts.

In Aspect 30, the method of Aspect 28 or 29 further includes that the configuration comprises a plurality of DRX on duration timer start occasions, wherein one or more of the plurality of DRX on duration timer start occasions start after a start of a corresponding scheduled DRX on duration of the DRX operation.

In Aspect 31, the method of any of Aspects 28-30 further includes that each of the plurality of DRX on duration timer start occasions is associated with a respective WUS monitoring occasion.

In Aspect 32, the method of any of Aspects 28-31 further includes that the potential DRX on duration is activated during an existing DRX on duration or a configured DRX on duration.

In Aspect 33, the method of any of Aspects 28-32 further includes that a value of the DRX on duration timer is configured via RRC signaling.

In Aspect 34, the method of any of Aspects 28-33 further includes that a value of the DRX on duration timer is an indicated value.

In Aspect 35, the method of any of Aspects 28-34 further includes that the configuration comprises a plurality of search space sets within the DRX on duration and prior to a scheduled arrival time of data, wherein at least one of the plurality of search space sets are deactivated prior to a subsequent scheduled arrival time of data.

In Aspect 36, the method of any of Aspects 28-35 further includes that a first search space set of the plurality of search space sets is active at a beginning of the DRX on duration, wherein a second search space set is activated if a data set is received within the DRX on duration.

In Aspect 37, the method of any of Aspects 28-36 further includes that the second search space set is deactivated prior to a next data set being received by the UE.

In Aspect 38, the method of any of Aspects 28-37 further includes that the second search space set is deactivated based on predefined events.

In Aspect 39, the method of any of Aspects 28-38 further includes that the predefined events comprise at least switching to a DRX off configuration or an expiration of an inactivity or retransmission timer.

In Aspect 40, the method of any of Aspects 28-39 further includes that the configuration comprises at least a first search space set active at a beginning of the DRX on duration, the method further including performing sparse monitoring of PDCCH within the first search space set prior to a scheduled burst arrival time.

In Aspect 41, the method of any of Aspects 28-40 further including activating a second search space set to perform dense monitoring of PDCCH within the second search space set, wherein the UE switches from the sparse monitoring of PDCCH to the dense monitoring of PDCCH.

In Aspect 42, the method of any of Aspects 28-41 further including receiving a downlink grant within the first search space set.

In Aspect 43, the method of any of Aspects 28-42 further includes that activation of the second search space set is indicated via DCI, wherein the second search space set is indicated by a value in the DCI.

In Aspect 44, the method of any of Aspects 28-43 further includes that activation of the second search space set is indicated based on reception of the downlink grant.

In Aspect 45, the method of any of Aspects 28-44 further includes that activation of the second search space set occurs after the scheduled burst arrival time.

In Aspect 46, the method of any of Aspects 28-45 further includes that the second search space set is deactivated prior to a next data set being received by the UE.

In Aspect 47, the method of any of Aspects 28-46 further includes that the second search space set is deactivated via DCI.

In Aspect 48, the method of any of Aspects 28-47 further includes that the second search space set is deactivated and the first search space set is activated based on predefined events or an expiration of an activity timer.

Aspect 49 is a device including one or more processors and one or more memories in electronic communication with the one or more processors and storing instructions executable by the one or more processors to cause the device to implement a method as in any of Aspects 28-48.

Aspect 50 is a system or apparatus including means for implementing a method or realizing an apparatus as in any of Aspects 28-48.

Aspect 51 is a non-transitory computer readable storage medium storing instructions executable by one or more processors to cause the one or more processors to implement a method as in any of Aspect 28-48.

Aspect 52 is a method of wireless communication at a UE comprising receiving a configuration from a base station comprising a configuration for discontinuous reception (DRX) operation, wherein the configuration comprises at least one blind decode indication during a DRX on duration of the DRX operation; monitoring for the at least one blind decode indication during the DRX on duration; and performing a blind decode operation based on the at least one blind decode indication.

In Aspect 53, the method of Aspect 52 further includes that the at least one blind decode indication is configured based on at least a periodicity, an offset, or a time frequency resource to monitor for the at least one blind decode indication.

In Aspect 54, the method of Aspect 52 or 53 further includes that the UE monitors for PDCCH during the blind decode operation based on the at least one blind decode indication.

In Aspect 55, the method of any of Aspects 52-54 further includes that the at least one blind decode indication informs the UE to perform the blind decode operation.

In Aspect 56, the method of any of Aspects 52-55 further includes monitoring for communication from the base station based on the at least one blind decode indication.

Aspect 57 is a device including one or more processors and one or more memories in electronic communication with the one or more processors and storing instructions executable by the one or more processors to cause the device to implement a method as in any of Aspects 52-56.

Aspect 58 is a system or apparatus including means for implementing a method or realizing an apparatus as in any of Aspects 52-56.

Aspect 59 is a non-transitory computer readable storage medium storing instructions executable by one or more processors to cause the one or more processors to implement a method as in any of Aspect 52-56.

Aspect 60 is a method of wireless communication at a UE comprising receiving a configuration from a base station comprising a configuration for SPS occasions; and monitoring for communication from the base station based on the SPS occasions, wherein the SPS occasions are scheduled to correspond with a scheduled arrival time of data.

In Aspect 61, the method of Aspect 60 further includes that the SPS occasions comprises a first SPS occasion and a second SPS occasion, wherein the UE does not wake up during the second SPS occasion if data is received during the first SPS occasion.

In Aspect 62, the method of Aspect 60 or 61 further includes that the first SPS occasion corresponds with the scheduled arrival time of the data.

In Aspect 63, the method of any of Aspects 60-62 further includes that the SPS occasions comprises a first SPS occasion and a second SPS occasion, wherein the UE wakes up during the second SPS occasion if data is not received during the first SPS occasion.

In Aspect 64, the method of any of Aspects 60-63 further includes that the first SPS occasion corresponds with the scheduled arrival time of the data and the second SPS occasion is after the scheduled arrival time of the data but prior to a subsequent arrival time of data.

Aspect 65 is a device including one or more processors and one or more memories in electronic communication with the one or more processors and storing instructions executable by the one or more processors to cause the device to implement a method as in any of Aspects 60-64.

Aspect 66 is a system or apparatus including means for implementing a method or realizing an apparatus as in any of Aspects 60-64.

Aspect 67 is a non-transitory computer readable storage medium storing instructions executable by one or more processors to cause the one or more processors to implement a method as in any of Aspect 60-64.

Aspect 68 is a method of wireless communication of a base station comprising configuring a UE with a configuration for DRX operation based on a scheduled arrival time of data, wherein the configuration comprises a time offset for a WUS occasion or a DRX on duration for a plurality of DRX cycles of the DRX operation; and transmitting communication to the UE based on the time offset associated with the WUS occasion or the DRX on duration for each of the plurality of DRX cycles.

In Aspect 69, the method of Aspect 68 further includes that a start time for the WUS occasion or the DRX on duration is delayed based on the time offset.

In Aspect 70, the method of Aspect 68 or 69 further includes that the start time of the WUS occasion or the DRX on duration is delayed after the scheduled arrival time of the data based on the time offset.

In Aspect 71, the method of any of Aspects 68-70 further includes that the UE does not monitor for PDCCH between the scheduled arrival time and the start time for the WUS occasion or the DRX on duration.

In Aspect 72, the method of any of Aspects 68-71 further includes that time offset shifts the start time for the WUS occasion or the DRX on duration to minimize jitter at the scheduled arrival time.

Aspect 73 is a device including one or more processors and one or more memories in electronic communication with the one or more processors and storing instructions executable by the one or more processors to cause the device to implement a method as in any of Aspects 68-72.

Aspect 74 is a system or apparatus including means for implementing a method or realizing an apparatus as in any of Aspects 68-72.

Aspect 75 is a non-transitory computer readable storage medium storing instructions executable by one or more processors to cause the one or more processors to implement a method as in any of Aspect 68-72.

Aspect 76 is a method of wireless communication of a base station comprising configuring a UE with a configuration for DRX operation, wherein the configuration comprises a sequence based WUS such that DRX operation is based on a sequence detected within the WUS; and transmitting communication to the UE based on the sequence based WUS.

In Aspect 77, the method of Aspect 76 further includes that the sequence based WUS is transmitted before each of a plurality of DRX on durations.

In Aspect 78, the method of Aspect 76 or 77 further includes that each of the plurality of DRX on durations has a corresponding WUS occasion transmitted for the sequence based WUS.

In Aspect 79, the method of any of Aspects 76-78 further includes that the sequence based WUS comprises an indication of a narrow bandwidth or wide bandwidth for the DRX operation.

In Aspect 80, the method of any of Aspects 76-79 further includes that the indication provides a bandwidth switching between the narrow bandwidth or the wide bandwidth.

In Aspect 81, the method of any of Aspects 76-80 further includes that the bandwidth switching is associated with reception of the sequenced based WUS.

In Aspect 82, the method of any of Aspects 76-81 further includes that the sequence based WUS comprises the indication of the narrow bandwidth, wherein the narrow bandwidth is utilized by the UE during the DRX operation to monitor for communication from the base station.

In Aspect 83, the method of any of Aspects 76-82 further includes that the sequence based WUS comprises the indication for the wide bandwidth, wherein the wide bandwidth is utilized by the UE during the DRX operation to monitor for communication from the base station.

In Aspect 84, the method of any of Aspects 76-83 further includes that a DRX on duration of the DRX operation utilizes the wide bandwidth to receive data from the base station.

In Aspect 85, the method of any of Aspects 76-84 further includes that the configuration comprises a DRX mask indicating a period for the UE to monitor for or not to monitor for the sequence based WUS.

In Aspect 86, the method of any of Aspects 76-85 further includes that the period for the UE to monitor for or not to monitor for the sequence based WUS of the DRX mask is in between scheduled arrival times of data.

In Aspect 87, the method of any of Aspects 76-86 further includes that the DRX mask comprises an off-period mask, wherein the UE does not monitor for the sequence based WUS during the off-period mask.

In Aspect 88, the method of any of Aspects 76-87 further includes that the off-period mask is configured by a set of parameters based on a periodicity and offsets for the off-period mask.

In Aspect 89, the method of any of Aspects 76-88 further includes that the DRX mask comprises an on-period mask, wherein the UE monitors for the sequence based WUS during the on-period mask.

In Aspect 90, the method of any of Aspects 76-89 further includes that the UE wakes up for DRX on durations during the on-period mask.

Aspect 91 is a device including one or more processors and one or more memories in electronic communication with the one or more processors and storing instructions executable by the one or more processors to cause the device to implement a method as in any of Aspects 76-90.

Aspect 92 is a system or apparatus including means for implementing a method or realizing an apparatus as in any of Aspects 76-90.

Aspect 93 is a non-transitory computer readable storage medium storing instructions executable by one or more processors to cause the one or more processors to implement a method as in any of Aspect 76-90.

Aspect 94 is a method of wireless communication at a base station comprising configuring a UE with a configuration for DRX operation, wherein the configuration comprises a WUS configuration comprising a plurality of WUS occasions within a DRX on duration of the DRX operation; and transmitting communication to the UE based on the WUS configuration.

In Aspect 95, the method of Aspect 94 further includes that the WUS configuration comprises a minimum time gap indicating a minimum gap between a WUS and a time when a DRX on duration timer starts.

In Aspect 96, the method of Aspect 94 or 95 further includes that the configuration comprises a plurality of DRX on duration timer start occasions, wherein one or more of the plurality of DRX on duration timer start occasions start after a start of a corresponding scheduled DRX on duration of the DRX operation.

In Aspect 97, the method of any of Aspects 94-96 further includes that each of the plurality of DRX on duration timer start occasions is associated with a respective WUS monitoring occasion.

In Aspect 98, the method of any of Aspects 94-97 further includes that the potential DRX on duration is activated during an existing DRX on duration or a configured DRX on duration.

In Aspect 99, the method of any of Aspects 94-98 further includes that a value of the DRX on duration timer is configured via RRC signaling.

In Aspect 100, the method of any of Aspects 94-99 further includes that a value of the DRX on duration timer is an indicated value.

In Aspect 101, the method of any of Aspects 94-100 further includes that the configuration comprises a plurality of search space sets within the DRX on duration and prior to a scheduled arrival time of data, wherein at least one of the plurality of search space sets are deactivated prior to a subsequent scheduled arrival time of data.

In Aspect 102, the method of any of Aspects 94-101 further includes that a first search space set of the plurality of search space sets is active at a beginning of the DRX on duration, wherein a second search space set is activated if a data set is received by the UE within the DRX on duration.

In Aspect 103, the method of any of Aspects 94-102 further includes that the second search space set is deactivated prior to a next data set being transmitted to the UE.

In Aspect 104, the method of any of Aspects 94-103 further includes that the second search space set is deactivated based on predefined events.

In Aspect 105, the method of any of Aspects 94-104 further includes that the predefined events comprise at least switching to a DRX off configuration or an expiration of an inactivity or retransmission timer.

Aspect 106 is a device including one or more processors and one or more memories in electronic communication with the one or more processors and storing instructions executable by the one or more processors to cause the device to implement a method as in any of Aspects 94-105.

Aspect 107 is a system or apparatus including means for implementing a method or realizing an apparatus as in any of Aspects 94-105.

Aspect 108 is a non-transitory computer readable storage medium storing instructions executable by one or more processors to cause the one or more processors to implement a method as in any of Aspect 94-105.

Aspect 109 is a method of wireless communication at a base station comprising configuring a UE with a configuration for DRX operation, wherein the configuration comprises at least one blind decode indication during a DRX on duration of the DRX operation; and transmitting the at least one blind decode indication during the DRX on duration, wherein the UE performs a blind decode operation based on the at least one blind decode indication.

In Aspect 110, the method of Aspect 109 further includes that the at least one blind decode indication is configured based on at least a periodicity, an offset, or a time frequency resource to monitor for the at least one blind decode indication.

In Aspect 111, the method of Aspect 109 or 110 further includes that the base station transmits a PDCCH during the blind decode operation based on the at least one blind decode indication.

In Aspect 112, the method of any of Aspects 109-111 further includes that the at least one blind decode indication informs the UE to perform the blind decode operation.

In Aspect 113, the method of any of Aspects 109-112 further includes transmitting communication to the UE based on the at least one blind decode indication.

Aspect 114 is a device including one or more processors and one or more memories in electronic communication with the one or more processors and storing instructions executable by the one or more processors to cause the device to implement a method as in any of Aspects 109-113.

Aspect 115 is a system or apparatus including means for implementing a method or realizing an apparatus as in any of Aspects 109-113.

Aspect 116 is a non-transitory computer readable storage medium storing instructions executable by one or more processors to cause the one or more processors to implement a method as in any of Aspect 109-113.

Aspect 117 is a method of wireless communication at a base station comprising configuring a UE with a configuration for SPS occasions; and transmitting communication to the UE based on the SPS occasions, wherein the SPS occasions are scheduled to correspond with a scheduled arrival time of data.

In Aspect 118, the method of Aspect 117 further includes that the SPS occasions comprises a first SPS occasion and a second SPS occasion, wherein the UE does not wake up during the second SPS occasion if data is transmitted during the first SPS occasion.

In Aspect 119, the method of Aspect 117 or 118 further includes that the first SPS occasion corresponds with the scheduled arrival time of the data.

In Aspect 120, the method of any of Aspects 117-119 further includes that the SPS occasions comprises a first SPS occasion and a second SPS occasion, wherein the UE wakes up during the second SPS occasion if data is not transmitted during the first SPS occasion.

In Aspect 121, the method of any of Aspects 117-120 further includes that the first SPS occasion corresponds with the scheduled arrival time of the data and the second SPS occasion is after the scheduled arrival time of the data but prior to a subsequent arrival time of data.

Aspect 122 is a device including one or more processors and one or more memories in electronic communication with the one or more processors and storing instructions executable by the one or more processors to cause the device to implement a method as in any of Aspects 117-121.

Aspect 123 is a system or apparatus including means for implementing a method or realizing an apparatus as in any of Aspects 117-121.

Aspect 124 is a non-transitory computer readable storage medium storing instructions executable by one or more processors to cause the one or more processors to implement a method as in any of Aspect 117-121.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication at a user equipment (UE), comprising:
a memory; and
at least one processor coupled to the memory and configured to:
receive, from a base station, a configuration for discontinuous reception (DRX) operation, wherein the configuration comprises a wake up signal (WUS) configuration comprising a plurality of WUS occasions within a DRX on duration of the DRX operation; and
monitor for communication from the base station based on the WUS configuration.

2. The apparatus of claim 1, further comprising a transceiver coupled to the at least one processor.

3. The apparatus of claim 1, wherein the WUS configuration comprises a minimum time gap indicating a minimum gap between a WUS and a time when a DRX on duration timer starts.

4. The apparatus of claim 1, wherein the configuration comprises a plurality of DRX on duration timer start occasions,
wherein one or more of the plurality of DRX on duration timer start occasions start after a start of a corresponding scheduled DRX on duration of the DRX operation.

5. The apparatus of claim 4, wherein each of the plurality of DRX on duration timer start occasions is associated with a respective WUS monitoring occasion.

6. The apparatus of claim 4, wherein a value of the DRX on duration timer is configured via radio resource control (RRC) signaling.

7. The apparatus of claim 1, wherein the configuration comprises a plurality of search space sets within the DRX on duration and prior to a scheduled arrival time of data, wherein at least one of the plurality of search space sets are deactivated prior to a subsequent scheduled arrival time of data.

8. The apparatus of claim 7, wherein a first search space set of the plurality of search space sets is active at a beginning of the DRX on duration, wherein a second search space set is activated if a data set is received within the DRX on duration.

9. The apparatus of claim 8, wherein the second search space set is deactivated prior to a next data set being received by the UE.

10. The apparatus of claim 8, wherein the second search space set is deactivated based on predefined events.

11. The apparatus of claim 10, wherein the predefined events comprise at least switching to a DRX off configuration or an expiration of an inactivity or retransmission timer.

12. The apparatus of claim 1, wherein the configuration comprises at least a first search space set active at a beginning of the DRX on duration, wherein the at least one processor is further configured to:
perform sparse monitoring of physical downlink control channel (PDCCH) within the first search space set prior to a scheduled burst arrival time.

13. The apparatus of claim 12, wherein the at least one processor is further configured to:
activate a second search space set to perform dense monitoring of the PDCCH within the second search space set, wherein the UE switches from the sparse monitoring of the PDCCH to the dense monitoring of the PDCCH.

14. The apparatus of claim 13, wherein the at least one processor is further configured to:
receive a downlink grant within the first search space set.

15. The apparatus of claim 14, wherein activation of the second search space set is indicated via downlink control information (DCI), wherein the second search space set is indicated by a value in the DCI.

16. The apparatus of claim 14, wherein activation of the second search space set is indicated based on reception of the downlink grant.

17. The apparatus of claim 13, wherein activation of the second search space set occurs after the scheduled burst arrival time.

18. The apparatus of claim 13, wherein the second search space set is deactivated prior to a next data set being received by the UE.

19. The apparatus of claim 18, wherein the second search space set is deactivated via DCI.

20. The apparatus of claim 13, wherein the second search space set is deactivated and the first search space set is activated based on predefined events or an expiration of an activity timer.

21. A method of wireless communication at a user equipment (UE), comprising:
receiving, from a base station, a configuration for discontinuous reception (DRX) operation, wherein the configuration comprises a wake up signal (WUS) configuration comprising a plurality of WUS occasions within a DRX on duration of the DRX operation; and
monitoring for communication from the base station based on the WUS configuration.

22. The method of claim 21, wherein the configuration comprises at least a first search space set active at a beginning of the DRX on duration, wherein the method further comprises:
performing sparse monitoring of physical downlink control channel (PDCCH) within the first search space set prior to a scheduled burst arrival time.

23. The method of claim 22, further comprising:
activating a second search space set to perform dense monitoring of the PDCCH within the second search space set, wherein the UE switches from the sparse monitoring of the PDCCH to the dense monitoring of the PDCCH.

24. The method of claim 23, further comprising:
receiving a downlink grant within the first search space set.

25. The method of claim 24, wherein activation of the second search space set is indicated via downlink control information (DCI), wherein the second search space set is indicated by a value in the DCI.

26. The method of claim 24, wherein activation of the second search space set is indicated based on reception of the downlink grant.

27. The method of claim 23, wherein activation of the second search space set occurs after the scheduled burst arrival time.

28. The method of claim 23, wherein the second search space set is deactivated prior to a next data set being received by the UE.

29. An apparatus for wireless communication at a user equipment (UE), comprising:
means for receiving, from a base station, a configuration for discontinuous reception (DRX) operation, wherein the configuration comprises a wake up signal (WUS) configuration comprising a plurality of WUS occasions within a DRX on duration of the DRX operation; and
means for monitoring for communication from the base station based on the WUS configuration.

30. A computer-readable medium storing computer executable code at a user equipment (UE), the code when executed by a processor causes the processor to:
receive, from a base station, a configuration for discontinuous reception (DRX) operation, wherein the configuration comprises a wake up signal (WUS) configuration comprising a plurality of WUS occasions within a DRX on duration of the DRX operation; and
monitor for communication from the base station based on the WUS configuration.
